(19) United States
(12) Patent Application Publication
(10) Pub. No.: US 2025/0349960 A1
(43) Pub. Date: Nov. 13, 2025

(54) Pad, Battery Module Including the Same, and Battery Pack

(71) Applicant: SK On Co., Ltd., Seoul (KR)

(72) Inventors: Jong Chan LEE, Daejeon (KR); Chi Min PARK, Daejeon (KR); Ji Yoon LEE, Daejeon (KR)

(21) Appl. No.: 19/191,018

(22) Filed: Apr. 28, 2025

(30) Foreign Application Priority Data
May 7, 2024 (KR) 10-2024-0059783

(51) Int. Cl. H01M 50/242; H01M 50/293

(52) U.S. Cl. CPC H01M 50/242; H01M 50/293

(57) ABSTRACT

The present disclosure relates to a pad, a battery module including the pad, and a battery pack according to embodiments of the present disclosure. The pad according to an embodiment may include a surface pressure layer having a shape of a sheet, a first barrier layer and a second barrier layer respectively stacked on both surfaces of the surface pressure layer in a predetermined stacking direction, and a reinforcement layer arranged in the predetermined stacking direction.

### CROSS-REFERENCE TO RELATED PATENT APPLICATION

The present application claims priority under 35 U.S.C. § 119(a) to Korean patent application number 10-2024-0059783 filed on May 7, 2024 in the Korean Intellectual Property Office, the entire disclosure of which is incorporated by reference herein.

### BACKGROUND OF THE INVENTION

### 1. Field

The present disclosure relates to a pad, a battery module including the same, and a battery pack, and more specifically, a pad capable of achieving high heat resistance with a small thickness and effectively mitigating the influence of a swelling phenomenon, a battery module including the pad, and a battery pack.

### 2. Description of the Related Art

A battery module is a part of a battery assembly. The battery module may include a plurality of battery cells in an internal storage space.

When a thermal runaway event occurs in one of the plurality of battery cells accommodated in the battery module, heat or flames generated in the battery cell may easily spread to adjacent cells, causing fatal safety problems.

On the other hand, when a battery is used for a long period of time, at least a part of a battery cell may expand during the charging/discharging process for reasons such as gas generation due to a side reaction, and this phenomenon may be referred to as swelling. Swelling of battery cells may cause physical damage to adjacent cells.

In order to prevent such damage caused by the swelling phenomenon, an attempt has been made to insert a frame-retardant member or a surface pressure member between adjacent battery cells. However, the insertion of the above member may further result in an increase in the volume of the battery module.

### SUMMARY OF THE INVENTION

An object of the present disclosure is to provide a pad capable of achieving high heat resistance performance with a small thickness, and at the same time, effectively mitigating the influence of a swelling phenomenon.

Another object of the present disclosure is to provide a battery module and a battery pack with improved safety and minimized volume increase.

Meanwhile, the present disclosure can be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

A pad according to embodiments of the present disclosure may include a surface pressure layer having a shape of a sheet, a first barrier layer and a second barrier layer respectively stacked on both surfaces of the surface pressure layer in a predetermined stacking direction, and a reinforcement layer arranged in the predetermined stacking direction.

A thickness of the pad may be between 0.55 mm and 5.5 mm.

The first barrier layer and the second barrier layer may each independently include at least one selected from fibers and an inorganic material.

Thicknesses of the first barrier layer and the second barrier layer may each be independently from 0.05 mm to 1.0 mm.

The surface pressure layer may include at least one selected from the group consisting of silicone, polyurethane (PU), acrylic, Ethylene-Propylene Diene Monomer (EPDM), Ethylene Vinyl Acetate (EVA), isoprene rubber, butadiene rubber, chloroprene rubber, and butyl rubber.

A thickness of the surface pressure layer may be between 0.2 mm and 4.0 mm.

A thickness of the surface pressure layer may be between 20% and 82% of a total thickness of the pad.

The reinforcement layer may include an expansion layer, and the expansion layer may be arranged in the predetermined stacking direction in at least one of between the surface pressure layer and the first barrier layer and between the surface pressure layer and the second barrier layer.

The expansion layer may include at least one selected from the group consisting of expanded graphite, silicate, and phosphorus-based flame retardants.

A thickness of the expansion layer may be between 0.015 mm and 1.0 mm.

The reinforcement layer may include an expansion layer, the surface pressure layer may include a first surface pressure layer and a second surface pressure layer stacked in the predetermined stacking direction, and the expansion layer may be arranged between the first surface pressure layer and the second surface pressure layer.

The reinforcement layer may further include a support layer, and the surface pressure layer may include a first surface pressure layer and a second surface pressure layer stacked in the predetermined stacking direction, and the support layer is arranged between the first surface pressure layer and the second surface pressure layer.

The support layer may include at least one selected from the group consisting of graphite, mica, aluminum hydroxide, magnesium hydroxide, wollastonite, and aerogel.

A thickness of the support layer may be between 0.01 mm and 2.5 mm.

The reinforcement layer may further include a support layer, and the support layer is stacked on at least one of the first barrier layer and the second barrier layer in the predetermined stacking direction.

The reinforcement layer may further include a support layer, and the support layer is arranged between the surface pressure layer and the expansion layer.

The reinforcement layer may further include a support layer, and the support layer may be arranged in the predetermined stacking direction in at least one of between the expansion layer and the first barrier layer and between the expansion layer and the second barrier layer.

A battery module according to embodiments of the present disclosure may include a plurality of battery cells stacked in a predetermined stacking direction, a module case accommodating the plurality of battery cells, and a pad arranged between at least one pair of battery cells adjacent to each other among the plurality of battery cells, wherein the pad comprises: a surface pressure layer having a shape of a sheet, a first barrier layer and a second barrier layer respectively stacked on both surfaces of the surface pressure layer in the predetermined stacking direction, and a reinforcement layer arranged in the predetermined stacking direction of the pad.

The plurality of battery cells may be stacked to include at least one battery cell having one surface where the pad is arranged, and another surface, opposing the one surface, where the pad is not arranged.

A battery pack according to embodiments of the present disclosure may include a battery cell stack, and a housing accommodating the battery cell stack comprising a plurality of battery cell stacks, wherein the battery cell stack comprises: a plurality of battery cells stacked in a predetermined stacking direction, and a pad arranged between at least one pair of battery cells adjacent to each other among the plurality of battery cells, and wherein the pad comprises: a surface pressure layer having a shape of a sheet, a first barrier layer and a second barrier layer respectively stacked on both surfaces of the surface pressure layer in the predetermined stacking direction, and a reinforcement layer arranged in the predetermined stacking direction.

### BRIEF DESCRIPTION OF THE DRAWINGS

FIG. 1 is a cross-sectional view of a pad according to an embodiment of the present disclosure.

FIG. 2 is a structural view illustrating a pad according to an embodiment of the present disclosure.

FIG. 3 is an exploded perspective view of a pad according to an embodiment of the present disclosure.

FIG. 4 is a cross-sectional view of a pad according to another embodiment of the present disclosure.

FIG. 5 is a structural view illustrating a pad according to another embodiment of the present disclosure.

FIG. 6 is an exploded perspective view of a pad according to another embodiment of the present disclosure.

FIG. 7 is a cross-sectional view of a pad according to another embodiment of the present disclosure.

FIG. 8 is a structural view illustrating a pad according to another embodiment of the present disclosure.

FIG. 9 is an exploded perspective view of a pad according to another embodiment of the present disclosure.

FIG. 10 is a cross-sectional view of a pad according to another embodiment of the present disclosure.

FIG. 11 is a structural view illustrating a pad according to another embodiment of the present disclosure.

FIG. 12 is an exploded perspective view of a pad according to another embodiment of the present disclosure.

FIG. 13 is a cross-sectional view of a pad according to another embodiment of the present disclosure.

FIG. 14 is a structural view illustrating a pad according to another embodiment of the present disclosure.

FIG. 15 is an exploded perspective view of a pad according to another embodiment of the present disclosure.

FIG. 16 is a cross-sectional view illustrating a pad according to another embodiment of the present disclosure.

FIG. 17 is a structural view illustrating a pad according to another embodiment of the present disclosure.

FIG. 18 is an exploded perspective view of a pad according to another embodiment of the present disclosure.

FIG. 19 is an exploded perspective view of a battery module according to an embodiment of the present disclosure.

FIG. 20 is a view of a battery module according to an embodiment of the present disclosure as viewed from above.

FIG. 21 is a view illustrating an example of a battery pack according to an embodiment of the present disclosure.

### DETAILED DESCRIPTION

Hereinafter, the present invention will be described in detail with reference to the accompanying drawing. However, those skilled in the art will appreciate that such embodiments described with reference to the accompanying drawing are provided to further understand the spirit of the present invention and do not limit subject matters to be protected as disclosed in the detailed description and appended claims. Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Being equal or uniform in this specification may mean being equal or uniform to each other within an acceptable margin of error unless otherwise specified. For example, the fact that certain components or physical property measurement values are the same may include the meaning that the two objects to be compared are not only completely the same, but also the same within the error range. On the other hand, the fact that certain physical property measurement values are the same may mean that the difference in measurement values between objects is approximately less than 5%, specifically less than 3%, and more specifically less than 1%.

In this specification, that the angles formed by the two objects are perpendicular or parallel or parallel to each other may include not only being geometrically perpendicular or parallel, but also being within a slight error range.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms.

Unless otherwise defined herein, “about” may be considered a value within 30%, 25%, 20%, 15%, 10%, or 5% of the stated value.

In this specification, the term “cross section” may mean a surface observed when a stacked object is cut in a direction perpendicular to a stacking surface.

As used herein, “arranged” may mean, without limitation, a positional relationship by which one object may be positioned adjacent to another object. By way of a non-limiting example, it may mean coating one object with another object, adhering one object to another object via an adhesive material, fusing one object to another by applying heat, pressure, or the like, or simply positioning at least a portion of one object within any space to abut at least a portion of another object.

In this specification, the “X direction”, the “Y direction”, and the “Z direction” may optionally refer to any one of directions constituting an orthogonal coordinate system with X, Y, and Z axes perpendicular to each other in a three-dimensional space.

As used herein, the term “lithium secondary battery” may refer to a battery that generates electrical energy by oxidation and reduction reactions when lithium ions are inserted and extracted in and from the positive and negative electrodes.

As used herein, the term “battery cell” may refer to a basic unit of a lithium secondary battery capable of charging and discharging electrical energy.

Hereinafter, the present disclosure will be described in detail. This is, however, illustrative only and not intended to limit the disclosure to the specific embodiments illustratively described.

### Pad

A pad 100 according to an embodiment of the present disclosure may include: a sheet-shaped surface pressure layer 120; a first barrier layer 131; and a second barrier layer 132 stacked on both surfaces of the surface pressure layer 120 in a predetermined stacking direction; and a reinforcement layer (110, 140) arranged in the stacking direction.

Each of the surface pressure layer 120, the first barrier layer 131, the second barrier layer 132, and the reinforcement layer (110, 140) may be in the form of a sheet, and may have the same area. However, the present disclosure is not limited thereto, and may be implemented in various forms, such as at least partially including a curved surface, as necessary, and at least one of the areas may be different. On the other hand, the surface pressure layer 120, the first barrier layer 131, the second barrier layer 132, and the reinforcement layer (110, 140) may have a rectangular or square cross-section based on a plane perpendicular to the stacking direction, but are not necessarily limited thereto. In addition, the cross-section may be formed as a circle, an ellipse, a triangle, a trapezoid, a parallelogram, or the like, or the cross-section may include at least a part of the circle, the ellipsis, the triangle, the trapezoid, or the parallelogram.

In an embodiment, the thickness of the pad may be 0.55 mm to 5.5 mm, specifically 0.6 mm to 5.0 mm, and more specifically 0.75 mm to 4.5 mm. When the thickness of the pad 100 is less than the above-described numerical range, the effect of blocking the propagation of heat or flames to the adjacent cell in the event of a thermal runaway event in the battery may be insignificant, and the effect of relieving the pressure applied to the adjacent cell when a swelling phenomenon occurs in one cell may be insignificant. On the other hand, when the thickness of the pad 100 exceeds the above-described numerical range, it is difficult to expect a significant improvement in the above-described propagation blocking effect compared to an increase in the thickness or weight of the pad 100, and thus, the energy efficiency per volume and per weight of the battery module and the battery pack including the pad 10 may be deteriorated.

In an embodiment, the first barrier layer 131 and the second barrier layer 132 may have thermal insulation, heat resistance, and fire resistance to perform a function of suppressing the propagation of heat or flames. Furthermore, the first barrier layer 131 and the second barrier layer 132 may be configured to maintain the shape and rigidity of the pad 100.

In an embodiment, the first barrier layer 131 and the second barrier layer 132 may each independently include at least one selected from fibers and an inorganic material.

In one embodiment, the fibers may include at least one selected from inorganic fibers and organic fibers. In a specific embodiment, the inorganic fibers may include at least one of silica fibers, alumina fibers, silica-alumina fibers, glass fibers, ceramic fibers, basalt fibers, and the organic fibers may include aramid fibers.

According to an exemplary embodiment, the fibers may be in the form of long fibers or short fibers. When the fibers are in the form of long fibers, the first barrier layer 131 and/or the second barrier layer 132 may include a form in which the fibers are woven. The first barrier layer 131 and/or the second barrier layer 132 may include, but may not be necessarily limited to, a woven or NCF fabric. On the other hand, the short fibers may not include long fibers. The diameter, length, and the like of the long fiber and/or short fiber may not be particularly limited.

In one embodiment, the inorganic material may include at least one selected from the group consisting of mica, silica, alumina, aluminum hydroxide, magnesium hydroxide, wollastonite, and aerogel.

In an embodiment, the thicknesses of the first barrier layer 131 and the second barrier layer 132 may each independently be 0.05 mm to 1.0 mm, specifically 0.07 mm to 0.9 mm, and more specifically 0.1 mm to 0.85 mm. When the thicknesses of the first barrier layer 131 and the second barrier layer 132 are less than the above-described numerical ranges, the effect of blocking the propagation of heat or flames to adjacent cells in the event of a thermal runaway event in the battery may be insignificant. On the other hand, when the thicknesses of the first barrier layer 131 and the second barrier layer 132 exceed the above-described numerical ranges, it is difficult to expect a significant improvement in the above-described propagation blocking effect as compared to an increase in the thickness or weight of the first barrier layer 131 and/or the second barrier layer 132, so that the energy efficiency per volume and per weight of the battery module and the battery pack including the same may be deteriorated, and furthermore, the thickness of the above-described first barrier layer 131, and/or the above-described second barrier layer 132 becomes excessive as compared to the total thickness of the above pad 100, so that the pressure blocking effect applied to the adjacent cell in the event of a swelling phenomenon may be deteriorated.

In one embodiment, the surface pressure layer 120 may perform a surface pressure function to relieve/offset pressure applied to adjacent cells due to physical deformation when a swelling phenomenon occurs in one battery cell due to continuous use of the battery. To this end, the surface pressure layer 120 may include an elastic material such that the surface pressure layer 120 may be compressed upon application of an external force and be restored upon termination of the application of the external force.

In an embodiment, the surface pressure layer 120 may include at least one selected from the group consisting of silicone, polyurethane (PU), acrylic, Ethylene-Propylene Diene Monomer (EPDM), Ethylene Vinyl Acetate (EVA), isoprene rubber, butadiene rubber, chloroprene rubber, and butyl rubber. In an embodiment, the butadiene rubber may mean butadiene rubber (BR), styrene butadiene rubber (SBR), acrylonitrile butadiene rubber, etc.

In an embodiment, the thickness of the surface pressure layer may be 0.2 mm to 4.0 mm, specifically 0.5 mm to 3.0 mm, and more specifically 0.7 mm to 2.5 mm. When the thickness of the surface pressure layer 120 is less than the above-described numerical range, the surface pressure performance of the pad 100 may be deteriorated. On the other hand, when the thickness of the surface pressure layer 120 exceeds the above-described numerical range, the pad 100 may be so thick that the energy efficiency per volume and per weight of the battery module and the battery pack including the pad 100 may be deteriorated.

In an embodiment, the thickness of the surface pressure layer 120 may be 20% to 82%, specifically 27% to 81%, and more specifically 32% to 80%, relative to the total thickness of the pad 100. When the thickness of the surface pressure layer 120 is less than the above-described numerical range relative to the total thickness of the pad 100, the surface pressure performance of the pad 100 may be deteriorated. On the other hand, when the thickness of the surface pressure layer 120 exceeds the above-described numerical range, the effect of blocking the propagation of heat or flames of the pad 100 may be insignificant.

In an embodiment, the reinforcement layer (110, 140) is arranged between any two of the first barrier layer 131, the surface pressure layer 120, and the second barrier layer 132 in the stacking direction, or is stacked on the first barrier layer 131 or the second barrier layer 132, and may have thermal insulation, heat resistance, and fire resistance so as to further reinforce the effect of blocking the propagation of heat or flames of the pad 100. The detailed configuration of the reinforcement layer (110, 140) will be described below.

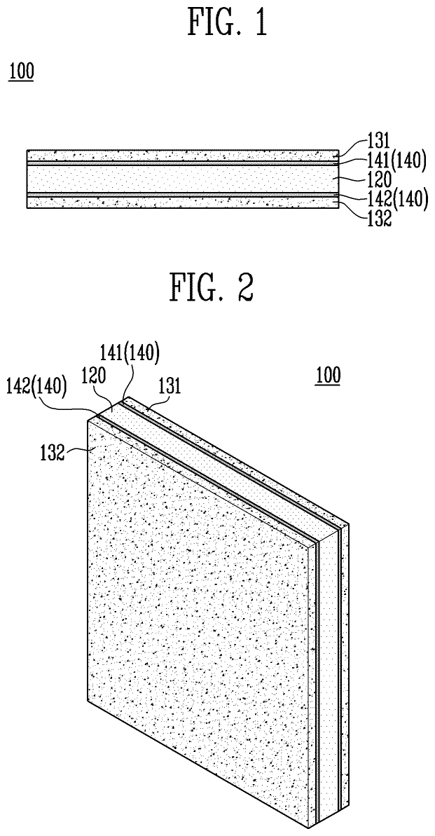

FIG. 1 is a cross-sectional view of a pad according to an embodiment of the present disclosure.

FIG. 2 is a structural view illustrating a pad according to an embodiment of the present disclosure.

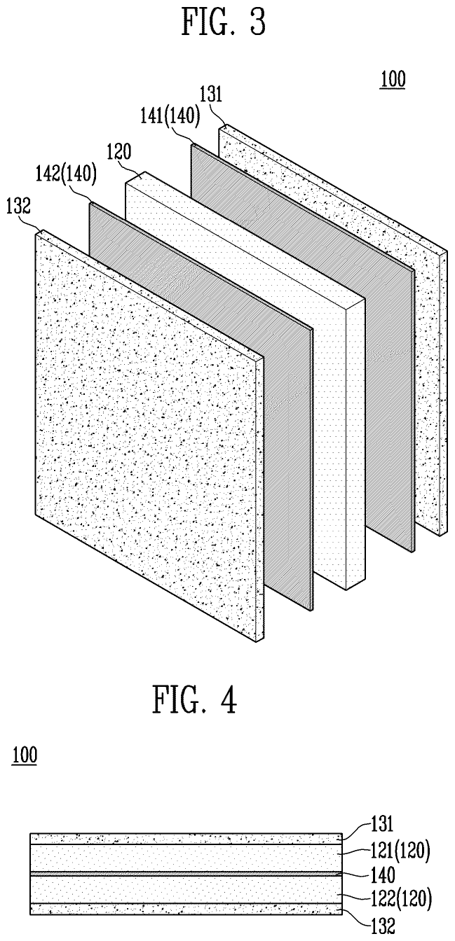

FIG. 3 is an exploded perspective view of a pad according to an embodiment of the present disclosure.

Referring to FIGS. 1 to 3, in an embodiment, the reinforcement layer (110, 140) includes an expansion layer 140, and the expansion layer 140 may be arranged in the stacking direction in at least one of between the surface pressure layer 120 and the first barrier layer 131 and between the surface pressure layer 120 and the second barrier layer 132.

In an embodiment, the expansion layer 140 may be arranged between the surface pressure layer 120 and the first barrier layer 131. In another embodiment, the expansion layer 140 may be arranged between the surface pressure layer 120 and the second barrier layer 132.

In an embodiment, the expansion layer 140 may include a first expansion layer 141 and a second expansion layer 142.

In an embodiment, the expansion layer 140 may be arranged between the surface pressure layer 120 and the first barrier layer 131 and between the surface pressure layer 120 and the second barrier layer 132 in the stacking direction. The first expansion layer 141 may be arranged between the surface pressure layer 120 and the first barrier layer 131, and the second expansion layer 142 may be arranged between the surface pressure layer 120 and the second barrier layer 132.

In one embodiment, the expansion layer 140 has thermal insulation, heat resistance, and fire resistance, and may expand when in contact with heat or flames to thereby block the path of movement of heat or flames. To this end, the expansion layer 140 may include a thermally expandable material.

In one embodiment, the expansion layer 140 may be arranged adjacent to the surface pressure layer 120. In a specific embodiment, the expansion layer 140 may be stacked on the surface pressure layer 120 or arranged between the surface pressure layers 120.

In an embodiment, the expansion layer 140 may be arranged between the first barrier layer 131 and the second barrier layer 132.

In one embodiment, the expansion layer 140 may expand from a temperature of 150° C. to 300° C. to a volume of 300% to 30,000% relative to the volume at room temperature.

Due to the material characteristics of the surface pressure layer 120, structural deformation may be observed at a temperature of 400° C. or higher. In general, when a thermal runaway event occurs in a battery, flames at a temperature of 1000° C. to 1100° C. may propagate between battery cells 200 at a high pressure, and the surface pressure layer 120 of the pad 100 arranged between the battery cells 200 may be lost by the flames. As the surface pressure layer 120 is lost, refractory layers (the barrier layers 131, 132, etc.) in the pad 100 may come into contact with each other, and thus, the heat resistance of the pad 100 may decrease.

In an embodiment, when the thermal runaway event occurs in the battery as described above, the expansion layer 140 suppresses the propagation of heat or flames through an endothermic reaction, and at the same time, expands upon contact with the heat or flames, thereby quickly compensating for the area of the surface pressure layer 120 being lost. Accordingly, even when the surface pressure layer 120 is lost in the event of the thermal runaway event, the expansion layer 140 compensates for the lost area and prevents contact between the refractory layers in the pad 100, thereby maintaining the distance between the refractory layers even in the event of the thermal runaway event. As the expansion layer 140 is included in this manner, specifically, the heat resistance of the pad 100 may be further improved by arranging the expansion layer 140 adjacent to the surface pressure layer 120.

In one embodiment, the expansion layer 140 may include at least one selected from the group consisting of expanded graphite, silicate, and phosphorus-based flame retardants.

In one embodiment, the silicate may include at least one selected from the group consisting of sodium silicate, potassium silicate, and lithium silicate.

In one embodiment, the thickness of the expansion layer 140 may be between 0.015 mm and 1.0 mm, specifically between 0.02 mm and 0.8 mm, and more specifically between 0.03 mm and 0.8 mm. When the thickness of the expansion layer 140 is less than the above-described numerical range, the effect of reinforcing the blocking of heat or flames propagation may be insignificant, and as a result, the effect of blocking heat or flames propagation of the pad 100 may be insignificant. On the other hand, when the thickness of the expansion layer 140 exceeds the above-described numerical range, it is difficult to expect a significant improvement in the above-described propagation blocking effect compared to an increase in the thickness or weight of the above-described expansion layer 140, and thus, the energy efficiency per volume and per weight of the battery module and the battery pack including the expansion layer 140 may be deteriorated.

In an embodiment, when the expansion layer 140 includes the first expansion layer 141 and the second expansion layer 142, the thickness of the expansion layer 140 may mean the sum of the thicknesses of the first and second expansion layers 141 and 142.

In an embodiment, the first expansion layer 141 and the second expansion layer 142 may have the same thickness. However, the present disclosure is not necessarily limited thereto, and the thicknesses of the first expansion layer 141 and the second expansion layer 142 may be different from each other within the above-described numerical range.

FIG. 4 is a cross-sectional view of a pad according to another embodiment of the present disclosure.

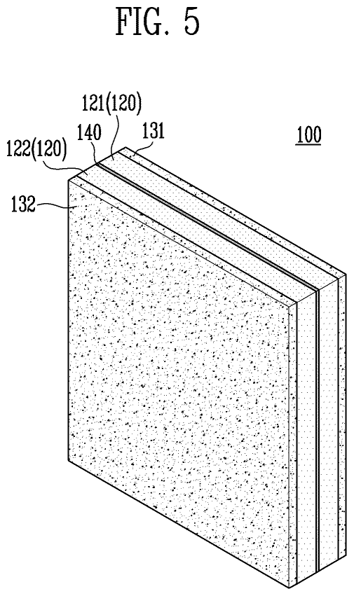

FIG. 5 is a structural view illustrating a pad according to another embodiment of the present disclosure.

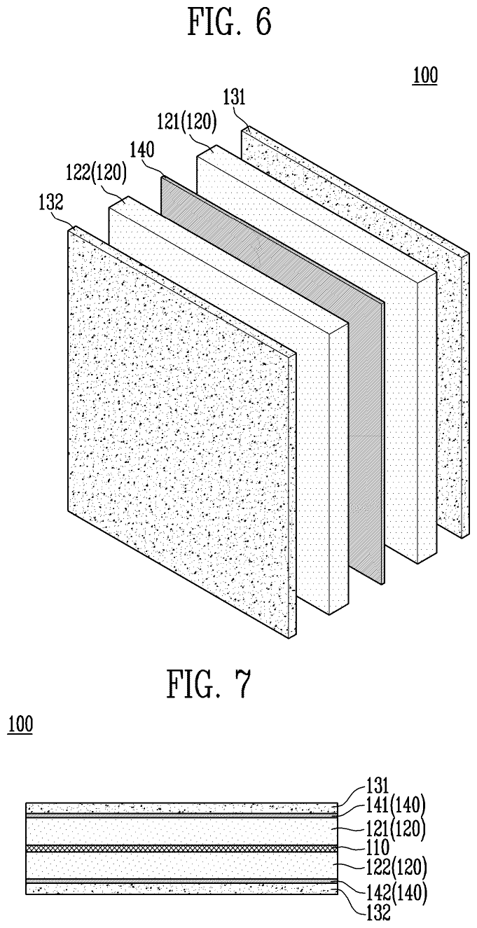

FIG. 6 is an exploded perspective view of a pad according to another embodiment of the present disclosure.

Referring to FIGS. 4 to 6, in an embodiment, the reinforcement layer (110, 140) may include the expansion layer 140, the surface pressure layer 120 may include a first surface pressure layer 121 and a second surface pressure layer 122 stacked in the stacking direction, and the expansion layer 140 may be arranged between the first and second surface pressure layers 121 and 122.

In an embodiment, the surface pressure layer 120 may include the first surface pressure layer 121 and the second surface pressure layer 122 stacked in the stacking direction. The first pressure layer 121 may be arranged closer to the first barrier layer 131 than the second barrier layer 132 in the pad 100, and the second pressure layer 122 may be arranged closer than the second barrier layer 132 than the first barrier layer 131 in the pad 100.

In an embodiment, when the surface pressure layer 120 includes the first pressure layer 121 and the second pressure layer 122, the thickness of the surface pressure layer 120 may mean the sum of the thicknesses of the first pressure-sensitive layer 121 and the first pressure-responsive layer 122.

In an embodiment, the first pressure layer 121 and the second pressure layer 122 may have the same thickness. However, the present disclosure is not necessarily limited thereto, and the thicknesses of the first surface pressure layer 121 and the second surface pressure layer 122 may be different from each other within the above-described numerical ranges.

In addition, the description of the surface pressure layer 120, the reinforcement layer (110, 140), and the expansion layer 140 as described with reference to FIGS. 1 to 3 may be applied hereto but the present disclosure is not limited thereto.

FIG. 7 is a cross-sectional view of a pad according to another embodiment of the present disclosure.

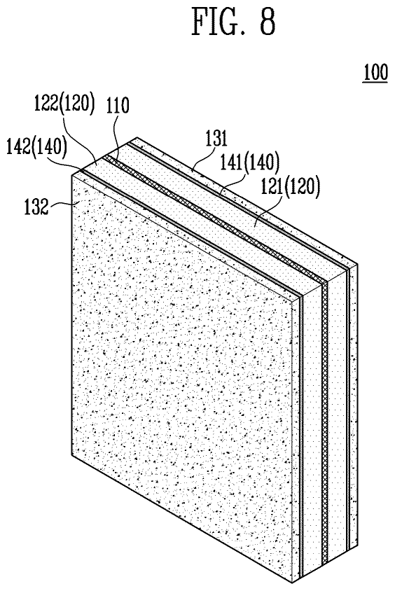

FIG. 8 is a structural view illustrating a pad according to another embodiment of the present disclosure.

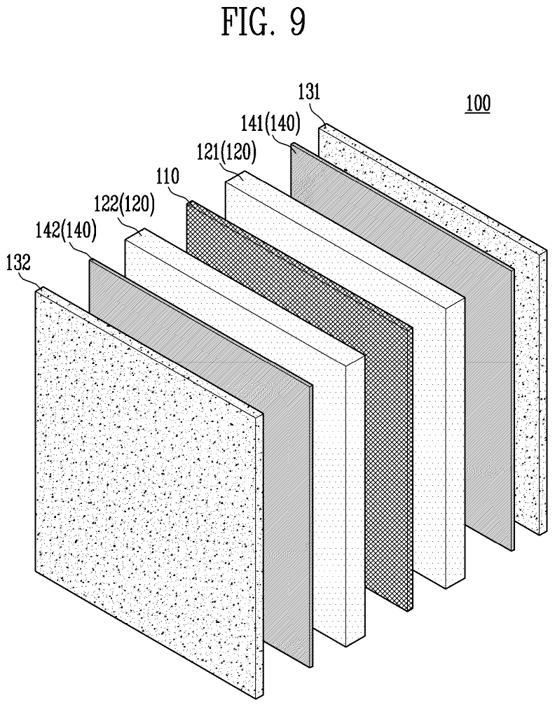

FIG. 9 is an exploded perspective view of a pad according to another embodiment of the present disclosure.

Referring to FIGS. 7 to 9, in an embodiment, the reinforcement layer (110, 140) may further include a support layer 110, the surface pressure layer 120 may include the first surface pressure layer 121 and the second surface pressure layer 122 stacked in the stacking direction, and the support layer 110 may be arranged between the first and second surface pressure layers 121 and 122.

In one embodiment, the support layer 110 has thermal insulation, heat resistance, and fire resistance, and may not expand or may expand very slightly even when in contact with heat or flames to thereby support the shape and rigidity of the pad 100.

In an embodiment, the support layer 110 may include at least one selected from the group consisting of graphite, mica, aluminum hydroxide, magnesium hydroxide, wollastonite, and aerogel. In a specific embodiment, the support layer 110 may include at least one of graphite and mica.

In an embodiment, the thickness of the support layer 110 may be 0.01 mm to 2.5 mm, specifically 0.03 mm to 2.0 mm, and more specifically 0.10 mm to 1.5 mm. When the thickness of the support layer 110 is less than the above-described numerical range, the effect of reinforcing the blocking of heat or flames propagation may be insignificant, and as a result, the effect of blocking heat or flames propagation of the pad 100 may be insignificant. On the other hand, when the thickness of the support layer 110 exceeds the above-described numerical range, it is difficult to expect a significant improvement in the above-described propagation blocking effect compared to an increase in the thickness or weight of the above-described support layer 110, and thus, the energy efficiency per volume and per weight of the battery module and the battery pack including the support layer 110 may be deteriorated.

In one embodiment, the support layer 110 may include a substrate and inorganic particles. In a specific embodiment, the inorganic particles may be coated on a substrate.

In one embodiment, the above substrate may mean, but is not necessarily limited to, polyethylene terephthalate (PET), polycarbonate (PC), acrylic or polyvinyl chloride (PVC), and the like, and may not be limited as long as the substrate corresponds to a material which may be used as a substrate for coating.

In an embodiment, the substrate is provided in a sheet form, and the thickness of the substrate may be 0.01 mm to 1.0 mm, specifically 0.015 mm to 0.8 mm, and more specifically 0.02 mm to 0.7 mm. When the thickness of the above-described substrate is less than the above-described numerical range, formation of the above-mentioned support layer 110 may be poor, and thus, the pad 100 according to an embodiment of the present disclosure may be structurally unstable. On the other hand, when the substrate exceeds the above-described numerical range, the thickness of the pad 100 may greater than necessary, resulting in a deterioration in poor energy efficiency per volume and per weight of the battery module.

In one embodiment, the inorganic particles may include at least one selected from the group consisting of graphite, mica, aluminum hydroxide, magnesium hydroxide, wollastonite, and aerogel. In a specific embodiment, the inorganic particles may include at least one of graphite and mica. In a more specific embodiment, the inorganic particles may include at least one of graphite and mica in the form of particles, and the inorganic particles may be configured in the form of a block in which the particles are aggregated.

According to an exemplary embodiment, the inorganic particles may be crystalline or amorphous ones.

In one embodiment, the support layer 110 may include a support binder and inorganic particles. In a specific embodiment, the inorganic particles may be bound by the support binder.

In one embodiment, the support binder may mean, but is not necessarily limited to, an epoxy-based binder, an acrylic binder, a polyurethane-based binder, and a polyester-based binder. The support binder may not be limited as long as the support binder includes a material which may be used as a binder in general.

In one embodiment, the inorganic particles may include at least one selected from the group consisting of graphite, mica, aluminum hydroxide, magnesium hydroxide, wollastonite, and aerogel. In a specific embodiment, the inorganic particles may include at least one of graphite and mica. In a more specific embodiment, the inorganic particles may include at least one of graphite and mica in the form of particles.

According to an exemplary embodiment, the inorganic particles may be crystalline or amorphous ones.

In an embodiment, the support layer 110 may include an inorganic sheet. In a specific embodiment, the inorganic sheet may mean a mica sheet.

In one embodiment, the support layer 110 may include an inorganic tape. In a specific embodiment, the inorganic tape may mean a mica tape.

In one embodiment, the support layer 110 may include an aerogel blanket.

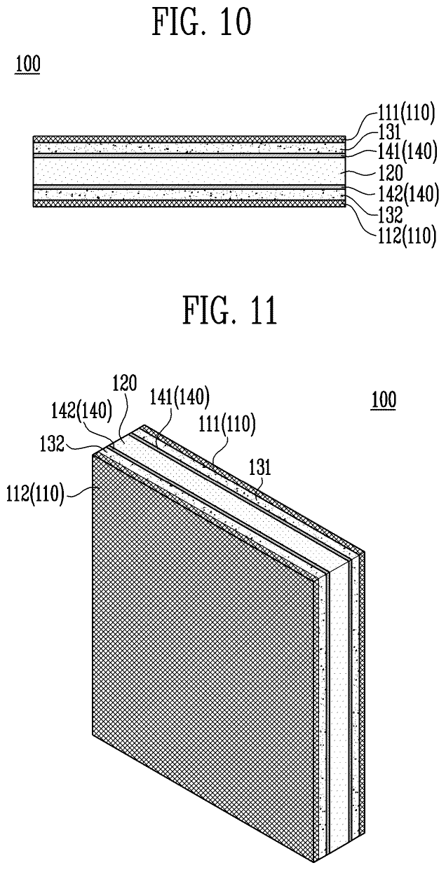

FIG. 10 is a cross-sectional view of a pad according to another embodiment of the present disclosure.

FIG. 11 is a structural view illustrating a pad according to another embodiment of the present disclosure.

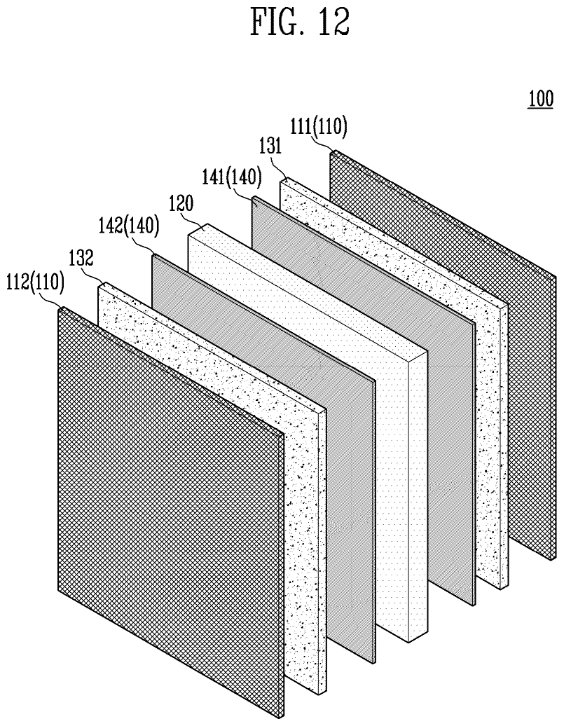

FIG. 12 is an exploded perspective view of a pad according to another embodiment of the present disclosure.

Referring to FIGS. 10 to 12, in an embodiment, the reinforcement layer (110, 140) further includes the support layer 110, and the support layer 110 may be stacked on at least one of the first barrier layer 131 and the second barrier layer 132 in the stacking direction.

In an embodiment, the support layer 110 may include a first support layer 111 and a second support layer 112.

In an embodiment, the support layer 110 may be stacked on the first barrier layer 131 and the second barrier layer 132 in the stacking direction. The first support layer 111 may be stacked on the first barrier layer 131, and the second support layer 112 may be stacked on the second barrier layer 132. The first support layer 111 and the second support layer 112 may be arranged on opposite outermost ends of the pad 100.

In an embodiment, when the support layer 110 includes the first support layer 111 and the second support layer 112, the thickness of the support layer 110 as described above may mean the sum of the thicknesses of the first and second support layers 111 and 112.

In an embodiment, the thicknesses of the first support layer 111 and the second support layer 112 may be the same. However, the present disclosure is not necessarily limited thereto, and the thicknesses of the first support layer 111 and the second support layer 112 may be different from each other within the above-described numerical range.

In an embodiment, when the support layer 110 includes the first support layer 111 and the second support layer 112, each of the first and second support layers 111 and 112 may independently include a substrate and inorganic particles, a support binder and inorganic particles, an inorganic sheet, an inorganic tape, or an aerogel blanket.

In addition, the descriptions of the first barrier layer 131, the reinforcement layer (110, 140), and the second barrier layer 132 described with reference to FIGS. 1 to 9 may be applied hereto but the present disclosure is not limited thereto.

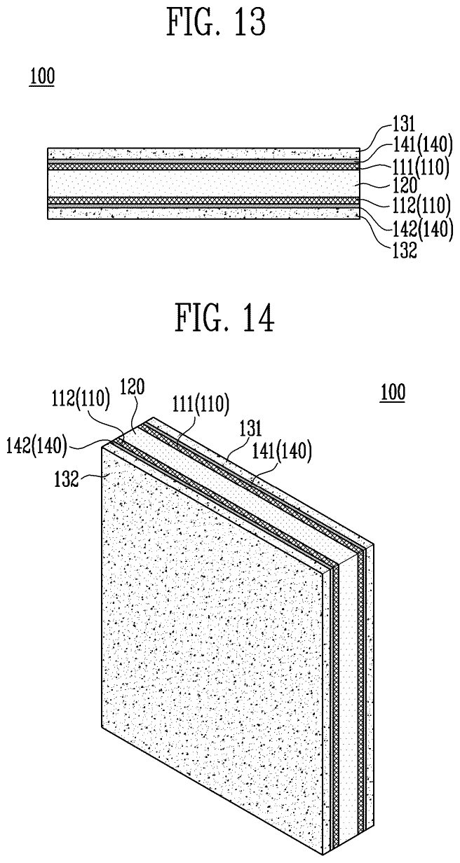

FIG. 13 is a cross-sectional view of a pad according to another embodiment of the present disclosure.

FIG. 14 is a structural view illustrating a pad according to another embodiment of the present disclosure.

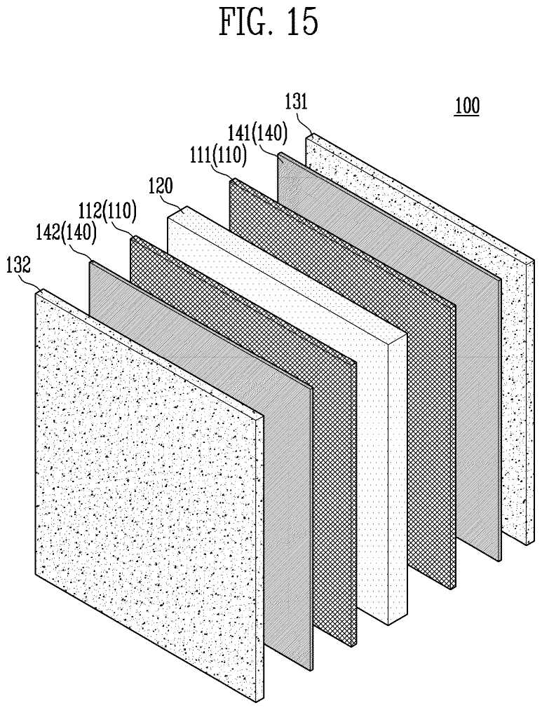

FIG. 15 is an exploded perspective view of a pad according to another embodiment of the present disclosure.

Referring to FIGS. 13 to 15, in an embodiment, the reinforcement layer (110, 140) further include the support layer 110, and the support layer 110 may be arranged between the surface pressure layer 120 and the expansion layer 140.

In an embodiment, when the expansion layer 140 is arranged between the surface pressure layer 120 and the first barrier layer 131, the support layer 110 may be arranged between the surface pressure layer 120 and the expansion layer 140. When the expansion layer 140 is arranged between the surface pressure layer 120 and the second barrier layer 132, the support layer 110 may be arranged between the surface pressure layer 120 and the expansion layer 140.

In an embodiment, the support layer 110 may include the first support layer 111 and the second support layer 112.

In an embodiment, as described above, the expansion layer 140 may include the first expansion layer 141 and the second expansion layer 142. The support layer 110 may be arranged between the surface pressure layer 120 and the first expansion layer 141 and between the surface pressure layer 120 and the second expansion layer 142 in the stacking direction. The first support layer 111 may be arranged between the surface pressure layer 120 and the first expansion layer 141, and the second support layer 112 may be arranged between the surface pressure layer 120 and the second expansion layer 142.

In addition, the descriptions of the expansion layer 140, the reinforcement layer (110, 140), the surface pressure layer 120, the first support layer 111, and the second support layer 112 as described with reference to FIGS. 1 to 12 may be applied hereto but the present disclosure is not limited thereto.

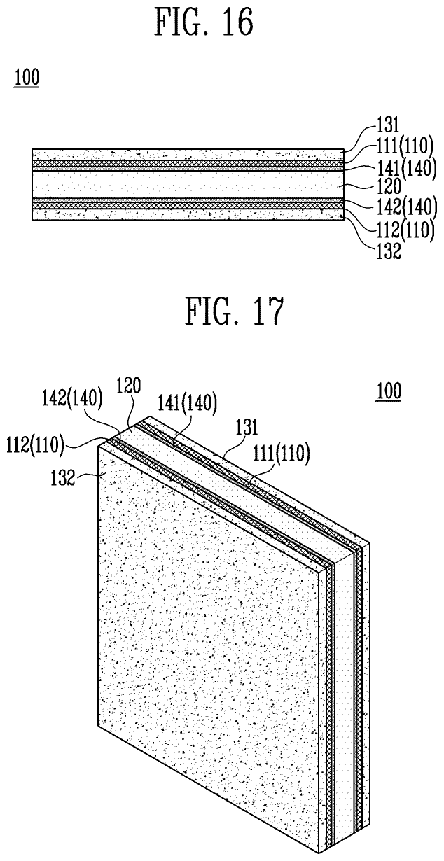

FIG. 16 is a cross-sectional view of a pad according to another embodiment of the present disclosure.

FIG. 17 is a structural view illustrating a pad according to another embodiment of the present disclosure.

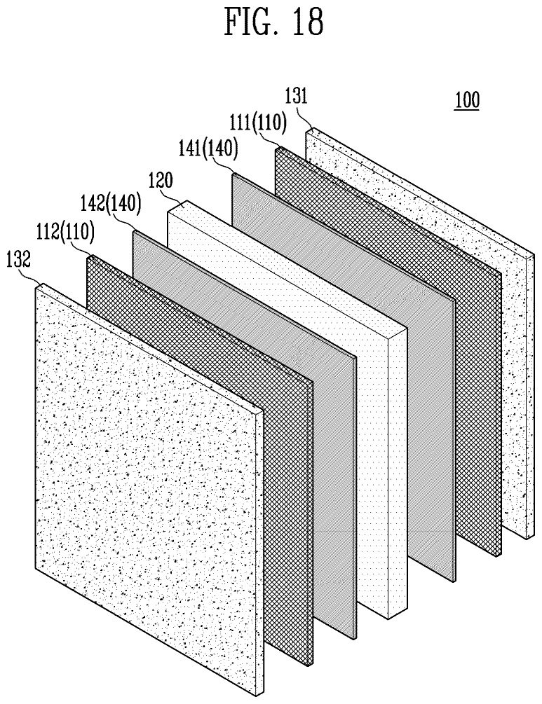

FIG. 18 is an exploded perspective view of a pad according to another embodiment of the present disclosure.

Referring to FIGS. 16 to 18, in an embodiment, the reinforcement layer (110, 140) further includes the support layer 110, and the support layer 110 may be arranged in the stacking direction in at least one of between the expansion layer 140 and the first barrier layer 131 and between the expansion layer 140 and the second barrier layer 132.

In an embodiment, when the expansion layer 140 is arranged between the surface pressure layer 120 and the first barrier layer 131, the support layer 110 may be arranged between the expansion layer 140 and the first barrier layer 131, and when the expansion layer 140 is arranged between the surface pressure layer 120 and the second barrier layer 132, the support layer 110 may be arranged between the expansion layer 140 and the second barrier layer 132.

In an embodiment, the support layer 110 may include the first support layer 111 and the second support layer 112.

In an embodiment, as described above, the expansion layer 140 may include the first expansion layer 141 and the second expansion layer 142. The support layer 110 may be arranged between the first expansion layer 141 and the first barrier layer 131 and between the second expansion layer 142 and the second barrier layer 132 in the stacking direction. The first support layer 111 may be arranged between the first expansion layer 141 and the first barrier layer 131, and the second support layer 112 may be arranged between the second expansion layer 142 and the second barrier layer 132.

In addition, the descriptions of the expansion layer 140, the reinforcement layer (110, 140), the surface pressure layer 120, the first support layer 111, and the second support layer 112 as described with reference to FIGS. 1 to 12 may be applied hereto but the present disclosure is not limited thereto.

As described in accordance with the above embodiments, the pad 100 for preventing a thermal runaway according to an embodiment of the present disclosure may effectively suppress the propagation of heat or flames when a thermal runaway event occurs in a battery even when the pad has a relatively small thickness, and at the same time, may effectively relieve surface pressure due to a swelling phenomenon which may occur due to continuous use of the battery.

FIGS. 1 to 18 are shown for convenience of description of the pad 100 according to an embodiment of the present disclosure. Since the shape, thickness, size, color, shading, and the like of the pad 100 and each layer are optional, various configurations may be made as needed without departing from the scope defined in the present disclosure.

### Battery Module and Battery Pack

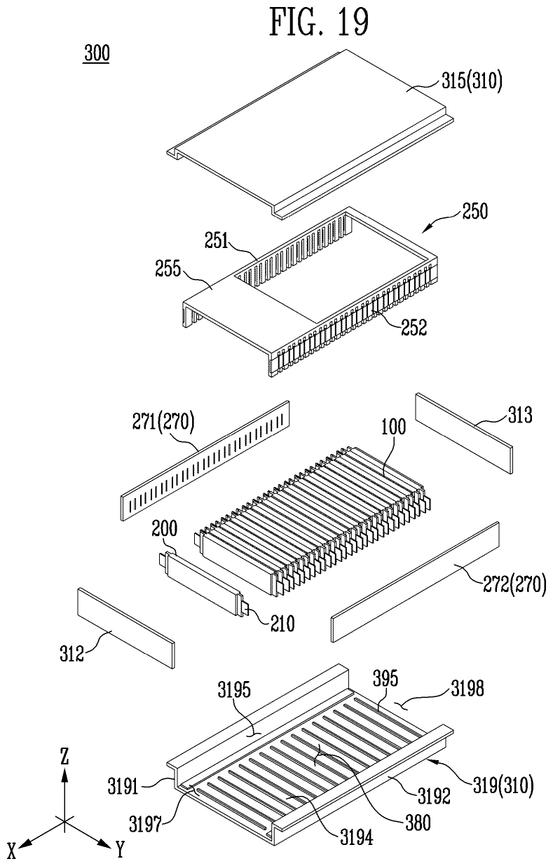

FIG. 19 is an exploded perspective view of a battery module 300 according to an embodiment of the present disclosure.

The battery module 300 according to an embodiment of the present disclosure includes: the plurality of battery cells 200 stacked in the predetermined stacking direction; a module case 310 accommodating the plurality of battery cells 200; and the pad 100 arranged between at least one pair of battery cells 200 adjacent to each other among the plurality of battery cells 200. The pad 100 may include: the sheet-shaped surface pressure layer 120; the first barrier layer 131 and the second barrier layer 132 respectively stacked on both surfaces of the surface pressure layer 120 in the predetermined stacking direction, and the reinforcement layer (110, 140) arranged in the stacking direction of the pad 100.

In an embodiment, the stacking direction of the plurality of battery cells 200 and the stacking direction for each layer in the pad 100 may be the same. However, the present disclosure is not necessarily limited thereto, and each stacking direction may be different as necessary.

In an embodiment, the battery cell 200 may include a cathode, an anode, a separator, and an electrolyte as main components. In an embodiment, the battery cell 200 may include an electrode assembly including a cathode, an anode, and a separator.

According to an exemplary embodiment, the cathode may include a cathode current collector and a cathode active material applied to at least one surface of the cathode current collector. The cathode current collector may include a known conductive material to the extent that cathode current collector may not cause a chemical reaction in the lithium secondary battery. The cathode current collector may include, for example, one of stainless steel, nickel (Ni), aluminum (Al), titanium (Ti), copper (Cu), and alloys thereof, and may be provided in various forms such as a film, a sheet, and foil. The cathode active material may include a material in and from which lithium ions may be inserted and extracted. The cathode active material may be, for example, a lithium metal oxide.

According to an exemplary embodiment, the anode may include an anode current collector and an anode active material applied to at least one surface of the anode current collector. The anode current collector may include a known conductive material to the extent that the anode current collector may not cause a chemical reaction in the lithium secondary battery. The anode current collector may include, for example, one of stainless steel, nickel (Ni), aluminum (Al), titanium (Ti), copper (Cu), and alloys thereof, and may be provided in various forms such as a film, a sheet, and foil. The anode active material may include a material in and from which lithium ions may be inserted and extracted. The anode active material may include one of, for example, a carbon-based material such as crystalline carbon, amorphous carbon, a carbon composite, or carbon fiber, a lithium alloy, silicon (Si) and tin (Sn), or a combination thereof.

According to an exemplary embodiment, each of the cathode and the anode may further include a binder and a conductive material, or improving mechanical stability and electrical conductivity.

According to an exemplary embodiment, each battery cell 200 may further include a separator to prevent an electrical short-circuit between the cathode and the anode and to generate an ion flow. The separator may include, for example, a porous polymer film or a porous nonwoven fabric.

Therefore, according to this embodiment, the electrode assembly may have a structure in which an anode, a separator, and a cathode are stacked in a predetermined stacking direction. The anode, the separator, and the cathode may be stacked in a stacking, stack-folding or Z-stacking manner.

According to an exemplary embodiment, each of the battery cells 200 may include an electrolyte to immerse the electrode assembly. The electrolyte may be a non-aqueous electrolyte. The electrolyte solution may include a lithium salt and an organic solvent, and may further include an additive if necessary.

According to another exemplary embodiment, each battery cell 200 may further include a solid electrolyte layer including an electrolyte in a solid form. Therefore, according to this embodiment, the electrode assembly may have a structure in which an anode, a solid electrolyte layer, and a cathode are stacked in the predetermined stacking direction.

The battery cell 200 may include the above-described main components and a cell case for accommodating the same. The battery cell 200 may further include an electrode lead 210. The electrode lead 210 may be connected to each of the cathode and the anode. The electrode lead 210 may protrude to the outside of the cell case to electrically connect the battery cell to the outside.

Referring to FIG. 19, the module case 310 may include a module body 319 forming a part of an accommodation space 380 accommodating the plurality of battery cells 200, and a module cover 315 coupled to the module body 319 to form the accommodation space 380 together.

In an embodiment, the plurality of battery cells 200 may be arranged in the module body 319 in a predetermined stacking direction (e.g., the X direction in FIG. 19).

In an embodiment, the module case 310 includes an open upper surface 3195, and may further include the module body 319 which receives the plurality of battery cells 200 through the open upper surface 3195, and the module cover 315 which is coupled to the module body 319 to close the open upper surface 3195.

Accordingly, the module cover 315 may be coupled to the module body 319 to form an upper surface of the accommodation space 380 or an upper surface of the module case 310. That is, the module cover 315 may be coupled to the module body 319 to close the open upper surface 3195 and form the accommodation space 380 together with the module body 319.

In an embodiment, the accommodation space 380 may include a space formed in the module body 319 to accommodate the stack of the plurality of battery cells 200.

In an embodiment, the module body 319 may have a channel shape or a U-shape with an open top. Referring to FIG. 19, both side surfaces 3197 and 3198 facing each other in the X direction among the side surfaces of the module body 319 may also be opened.

In an embodiment, the module body 319 may include a body bottom surface 3194 which forms a bottom surface of the accommodation space 380, and body side surfaces 3191 and 3192 which extend toward the module cover 315 on edges (not shown) of the body bottom surface 3194 which are provided next to each other in the stacking direction. The free ends of the body side surfaces 3191 and 3192 may be bent to form flanges (not shown), which may allow for easy coupling with the module cover 315.

In an embodiment, the height of the module body 319 may be less than the heights of the plurality of battery cells 200. However, the present disclosure is not necessarily limited thereto, and if necessary, the height of the module body 319 may be greater than or equal to those of the plurality of battery cells 200.

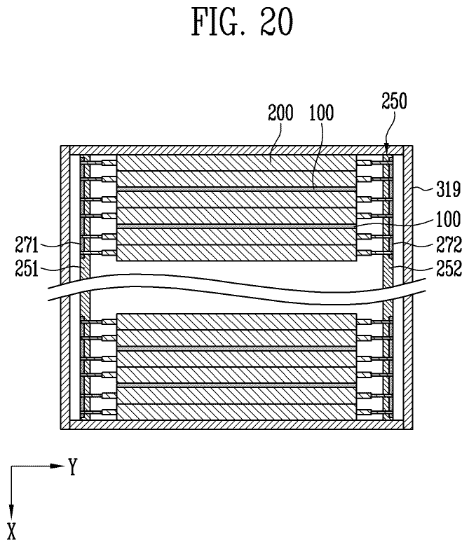

FIG. 20 is a view of a battery module according to an embodiment of the present disclosure as viewed from above.

Referring to FIGS. 19 and 20, in an embodiment, the pad 100 may be arranged between at least one pair of battery cells 200 adjacent to each other among the plurality of battery cells 200.

As described above, the plurality of battery cells 200 may be stacked in the predetermined stacking direction. In an embodiment, the pad 100 may also be arranged between at least one pair of battery cells 200 adjacent to each other among the plurality of battery cells 200 in the stacking direction. For example, referring to FIGS. 19 and 20, an example in which long edges of the plurality of battery cells 200 are provided next to each other in the Y direction is illustrated. The plurality of battery cells 200 and the pad 100 may be stacked in the X direction.

In a specific embodiment, the pad 100 may be arranged to abut between at least one pair of battery cells 200 adjacent to each other among the plurality of battery cells 200.

In one embodiment, each of the pads 100 may be arranged against only the cell case of the battery cell 200. That is, each of the pads 100 may not be in contact with the electrode lead 210 of the battery cell 200. Referring to FIGS. 19 and 20, only the electrode lead 210 is shown to protrude outwards. This may mean that each of the pads 100 is arranged to abut only the cell case of the battery cell 200. However, the present disclosure is not necessarily limited thereto, and various arrangements may be shown as necessary.

In an embodiment, the plurality of battery cells 200 may be stacked to include at least one battery cell 200 such that the pad 100 may be arranged on one surface thereof and the pad 100 may not be arranged on another surface opposite to the one surface. That is, the plurality of battery cells 200 may be stacked to include one or more configurations in which battery cell 200-battery cell 200-pad 100 are stacked in this order.

Referring to FIG. 20, in an embodiment, the plurality of battery cells 200 may be stacked so that the pad 100 may be arranged on one surface of each of the battery cells 200, except one of the battery cells 200 located at the outermost edge in the stacking direction, and the pad 100 may not be arranged on another surface opposite to the one surface. That is, the plurality of battery cells 200 may be stacked such that one pad 100 may be arranged per two battery cells 200 in the stacking direction.

However, the present disclosure is not necessarily limited thereto, and if necessary, the pad 100 may be located between the battery cells 200, or may be located between battery groups in which the plurality of battery cells 200 are grouped in any number.

In an embodiment, the pad 100 may include the sheet-shaped pressure layer 120; the first barrier layer 131 and the second barrier layer 132 respectively stacked on both surfaces of the surface pressure layer 120 in the stacking direction; and the reinforcement layer (110, 140) arranged in the stacking directions.

In an embodiment, the stacking direction may mean the same direction as the stacking direction of the plurality of battery cells 200 as described above.

In one embodiment, the thickness of the pad 100 may be between 0.55 mm and 5.5 mm. Specifically, the thickness of the pad 100 may be 0.6 mm to 5.0 mm, and more specifically, 0.75 mm to 4.5 mm.

In an embodiment, the first barrier layer 131 and the second barrier layer 132 may each independently include at least one selected from fibers and an inorganic material.

In an embodiment, each of the thicknesses of the first barrier layer 131 and the second barrier layer 132 may independently be 0.05 mm to 1.0 mm. Specifically, 0.07 mm to 0.9 mm, and more specifically, 0.1 mm to 0.85 mm.

In an embodiment, the surface pressure layer 120 may include at least one selected from the group consisting of silicone, polyurethane (PU), acrylic, Ethylene-Propylene Diene Monomer (EPDM), Ethylene Vinyl Acetate (EVA), isoprene rubber, butadiene rubber, chloroprene rubber, and butyl rubber.

In one embodiment, the thickness of the surface pressure layer 120 may be between 0.2 mm and 4.0 mm. Specifically, the thickness of the surface pressure layer 120 may be 0.5 mm to 3.0 mm, and more specifically, 0.7 mm to 2.5 mm.

In one embodiment, the thickness of the surface pressure layer 120 may be between 20% and 82% of the total thickness of the pad 100. Specifically, the thickness of the surface pressure layer 120 may be 27% to 81% of the total thickness of the pad 100, and more specifically, 32% to 80%.

In an embodiment, the reinforcement layer (110, 140) includes the expansion layer 140, and the expansion layer 140 may be arranged in the stacking direction in at least one of between the surface pressure layer 120 and the first barrier layer 131 and between the surface pressure layer 120 and the second barrier layer 132.

In one embodiment, the expansion layer 140 may include at least one selected from the group consisting of expanded graphite, silicate, and phosphorus-based flame retardants.

In one embodiment, the thickness of the expansion layer 140 may be between 0.015 mm and 1.0 mm. Specifically, the thickness of the expansion layer 140 may be 0.02 mm to 0.8 mm, and more specifically, 0.03 mm to 0.8 mm.

In an embodiment, the reinforcement layer (110, 140) includes the expansion layer 140, the surface pressure layer 120 includes the first surface pressure layer 121 and the second surface pressure layer 122 stacked in the stacking direction, and the expansion layer 140 may be arranged between the first surface pressure layer 121 and the second surface pressure layer 122.

In an embodiment, the reinforcement layer (110, 140) may further include the support layer 110, the surface pressure layer 120 may include the first surface pressure layer 121 and the second surface pressure layer 122 which are stacked in the stacking direction, and the support layer 110 may be arranged between the first and second surface pressure layers 121 and 122.

In an embodiment, the support layer 110 may include at least one selected from the group consisting of graphite, mica, aluminum hydroxide, magnesium hydroxide, wollastonite, and aerogel.

In one embodiment, the thickness of the support layer 110 may be between 0.01 mm and 2.5 mm. Specifically, the thickness of the support layer 110 may be 0.03 mm to 2.0 mm, and more specifically, 0.10 mm to 1.5 mm.

In an embodiment, the reinforcement layer (110, 140) further includes the support layer 110, and the support layer 110 may be stacked on at least one of the first barrier layer 131 and the second barrier layer 132 in the stacking direction.

In one embodiment, the reinforcement layer (110, 140) further includes the support layer 110, wherein the support layer 110 may be arranged between the surface pressure layer 120 and the expansion layer 140.

In an embodiment, the reinforcement layer (110, 140) further includes the support layer 110, and the support layer 110 may be arranged in the stacking direction in at least one of between the expansion layer 140 and the first barrier layer 131 and between the expansion layer 140 and the second barrier layer 132.

Referring to FIGS. 19 and 20, in an embodiment, the thickness of the pad 100 and each layer may mean the average distance in the X direction of the pad 100 or each layer.

In addition, the description of the pad 100 as described above with reference to FIGS. 1 to 18 may be applied hereto but the present disclosure is not limited thereto.

In an embodiment, the battery module 300 may further include other components for driving the battery module 300 in addition to the battery cell 200, the module case 310, and the pad 100.

Referring to FIG. 19, in an embodiment, the battery module 300 may further include end plates 312 and 313 on both ends of the stack of the plurality of battery cells 200 in the stacking direction. In a specific embodiment, the end plates 312 and 313 may be provided at both ends of the stack or connected to the side surfaces 3197 and 3198 of the module body 319. In an embodiment, the end plates 312 and 313 may be configured to prevent both sides of the stack of the plurality of battery cells 200 from being exposed to the outside.

In an embodiment, the battery module 300 may include a busbar 270 electrically connected to the plurality of battery cells 200.

In an embodiment, the battery module 300 may further include busbar frames 251, 252, and 255 supporting the busbar 270 and the plurality of battery cells 200.

In an embodiment, a configuration including the busbar 270 and the busbar frames 251, 252, and 255 may be referred to as a busbar assembly 250. The busbar assembly 250 may include the busbar 270 electrically connected to the plurality of battery cells 200.

In an embodiment, the busbar frames 251, 252, and 255 may be electrically connected to the outside to store (or charge) electrical energy in the plurality of battery cells 200 or to supply (or discharge) electrical energy stored in the plurality of battery cells 200 to the outside.

In an embodiment, the busbar assembly 250 may include a first busbar frame 251 and a second busbar frame 252 extending in a stacking direction of the plurality of battery cells 200 with the plurality of battery cells 200 interposed therebetween.

In an embodiment, the busbar assembly 250 may further include a support frame 255 located on one side of the busbar assembly 150 and connecting the first busbar frame 251 and the second busbar frame 252.

In an embodiment, the support frame 255 may prevent deformation of and support the first busbar frame 251 and the second busbar frame 252.

In an embodiment, a part of an electrical device for sensing and controlling the plurality of battery cells 200 may be arranged on the support frame 255.

Referring to FIG. 19, the busbar assembly 250 is illustrated in a case where the electrode leads 210 of the battery cells 200 are formed in opposite direction. However, this is not necessarily limiting, and depending on the need, the electrode leads 210 of the battery cells 200 may be formed in the same direction. In such a case, the busbar frames 251, 252, 255 may be positioned on one side of the battery cell 200, for example, at the upper side of the battery cell 200, and electrically connected accordingly.

Referring to FIG. 19, in an embodiment, the busbar assembly 250 may have a tunnel shape.

In an embodiment, the lengths of the first busbar frame 251 and the second busbar frame 252 in the stacking direction may be greater than the length of the support frame 255.

In an embodiment, the support frame 255 may be connected to the first busbar frame 251 and the second busbar frame 252 to cover an upper portion of at least some of the plurality of battery cells 200. Alternatively, the support frame 255 may be configured to cover an upper portion of all of the plurality of battery cells 200.

In an embodiment, the busbar 270 may include a first busbar 271 supported by the first busbar frame 251 and electrically connected to one of the electrode leads of the battery cell 200, and a second busbar 272 supported by the second busbar frame 252 and electrically connected to another electrode lead of the battery cell 200.

In an embodiment, the first busbar 271 and the second busbar 272 may be located further away from the plurality of battery cells 200 than the first busbar frame 251 and the second busbar frame 252, respectively. That is, the first busbar 271 and the second busbar 272 may be located closer to the body side surfaces 3191 and 3192 than the first bus bar frame 251 and the second bus bar frame 252, respectively. The electrode lead of each of the battery cell 200 may be inserted into a slit hole (not shown) formed in the first busbar frame 251 and the second busbar frame 252 to be electrically connected to the first busbar 271 and the second busbar 272. However, the present disclosure is not necessarily limited thereto, and if necessary, each of the electrode leads may be electrically connected to the first busbar 271 and the second busbar 272 in a manner different from which described above.

In an embodiment, the battery module 300 may further include a heat dissipation portion 395 located between the body bottom surface 3194 and the plurality of battery cells 200 for transferring heat generated in the plurality of battery cells 200 to the outside of the battery module 300.

In an embodiment, the heat dissipation portion 395 may include an adhesive material having thermal conductivity.

In an embodiment, the heat dissipation portion 395 may adhere the plurality of battery cells 200 to the body bottom surface 3194. To this end, the heat dissipation portion 395 may be sprayed or applied onto the body bottom surface 3194.

For convenience of description, although FIGS. 19 and 20 illustrate the battery module 300 in which the battery cell 200 is a pouch-type battery cell, the present disclosure is not necessarily limited thereto, and the battery module 300 is also applicable to a prismatic battery cell, a cylindrical battery cell, or the like. Further, the battery module 300 is also applicable to another structure other than those shown in FIGS. 19 and 20 without departing from the scope of the present disclosure.

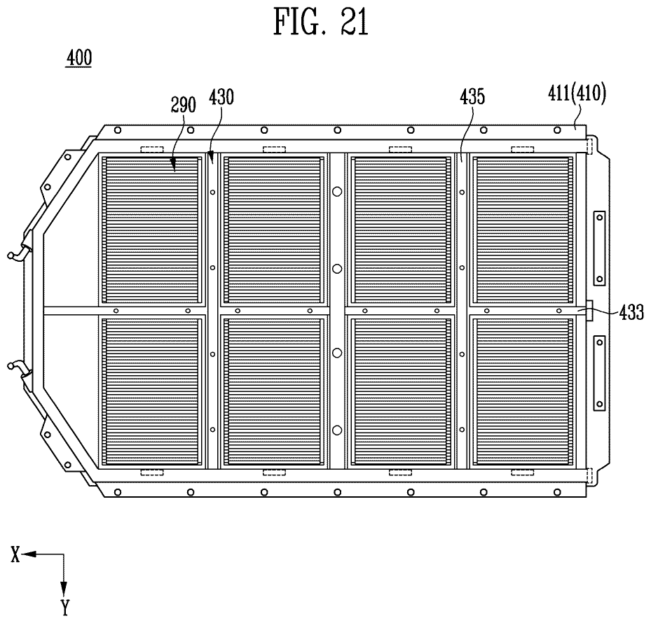

FIG. 21 is a view illustrating an example of a battery pack 400 according to an embodiment of the present disclosure.

Referring to FIG. 21, the battery pack 400 according to an embodiment of the present disclosure may include: a plurality of battery cell stacks 290; a housing 410 for accommodating the plurality of battery cell stacks 290 in each of which the plurality of battery cells 200 are stacked in a predetermined stacking direction; and the pad 100 arranged between at least a pair of battery cells 200 adjacent to each other among the plurality of battery cells 200. The pad 100 may include: the sheet-shaped surface pressure layer 120; the first barrier layer 131 and the second barrier layer 132 respectively stacked on both surfaces of the surface pressure layer 120 in the predetermined stacking direction, and the reinforcement layer (110, 140) arranged in the stacking direction.

The battery pack 400 according to an embodiment of the present disclosure may be in the form of a Cell to Pack P (CT) structure in which the battery cell stack 290 having the plurality of stacked battery cells 200 is accommodated in the form of a pack without the structure of the battery module 300.

In an embodiment, the battery cell stack 290 may include the plurality of battery cells 200 stacked in the predetermined stacking direction and the pad 100 arranged between at least one pair of battery cells 200 adjacent to each other among the plurality of battery cells 200.

In one embodiment, the housing 410 may include a receiving body 411 which receives the plurality of battery cell stacks 290 and a receiving cover (not shown) which couples to the receiving body 411.

In one embodiment, the housing 410 may further include a partition 430 defining a space in the housing 410 in which each of the battery cell stacks 290 is received.

In an embodiment, the partition 430 may include a first frame 433 which horizontally partitions a space in which each of the battery cell stacks 290 is accommodated in the housing 410, and a second frame 435 which vertically partitions the space in which each the battery cell stack 290 is housed. With the above configuration of the partition 430, the plurality of battery cell stacks 290 arranged in the housing 410 may be accommodated in the housing 410 according to a predetermined accommodating method.

Alternatively, the battery pack 400 according to an embodiment of the present disclosure may include a plurality of battery modules 300. Each of the plurality of battery modules 300 may be the same as the battery module 300 as described above.

In an embodiment, the pad 100 may include the sheet-shaped surface pressure layer 120; the first barrier layer 131 and the second barrier layer 132 respectively stacked on both surfaces of the surface pressure layer 120 in the stacking direction; and the reinforcement layer (110, 140) arranged in the stacking directions.

In an embodiment, the stacking direction may mean the same direction as the stacking direction of the plurality of battery cells 200 as described above.

In one embodiment, the thickness of the pad 100 may be between 0.55 mm and 5.5 mm. Specifically, the thickness of the pad 100 may be 0.6 mm to 5.0 mm, and more specifically, 0.75 mm to 4.5 mm.

In an embodiment, the first barrier layer 131 and the second barrier layer 132 may each independently include at least one selected from fibers and an inorganic material.

In an embodiment, the thicknesses of the first barrier layer 131 and the second barrier layer 132 may each independently be 0.05 mm to 1.0 mm. Specifically, 0.07 mm to 0.9 mm, and more specifically, 0.1 mm to 0.85 mm.

In an embodiment, the surface pressure layer 120 may include at least one selected from the group consisting of silicone, polyurethane (PU), acrylic, Ethylene-Propylene Diene Monomer (EPDM), Ethylene Vinyl Acetate (EVA), isoprene rubber, butadiene rubber, chloroprene rubber, and butyl rubber.

In one embodiment, the thickness of the surface pressure layer 120 may be between 0.2 mm and 4.0 mm. Specifically, the thickness of the surface pressure layer 120 may be 0.5 mm to 3.0 mm, and more specifically, 0.7 mm to 2.5 mm.

In one embodiment, the thickness of the surface pressure layer 120 may be between 20% and 82% of the total thickness of the pad 100. Specifically, the thickness of the surface pressure layer 120 may be 27% to 81% of the total thickness of the pad 100, and more specifically, 32% to 80%.

In an embodiment, the reinforcement layer (110, 140) includes the expansion layer 140, and the expansion layer 140 may be arranged in the stacking direction in at least one of between the surface pressure layer 120 and the first barrier layer 131 and between the surface pressure layer 120 and the second barrier layer 132.

In one embodiment, the expansion layer 140 may include at least one selected from the group consisting of expanded graphite, silicate, and phosphorus-based flame retardants.

In one embodiment, the thickness of the expansion layer 140 may be between 0.015 mm and 1.0 mm. Specifically, the thickness of the expansion layer 140 may be 0.02 mm to 0.8 mm, and more specifically, 0.03 mm to 0.8 mm.

In an embodiment, the reinforcement layer (110, 140) includes the expansion layer 140, the surface pressure layer 120 includes the first surface pressure layer 121 and the second surface pressure layer 122 stacked in the stacking direction, and the expansion layer 140 may be arranged between the first surface pressure layer 121 and the second surface pressure layer 122.

In an embodiment, the reinforcement layer (110, 140) may further include the support layer 110, the surface pressure layer 120 may include the first surface pressure layer 121 and the second surface pressure layer 122 which are stacked in the stacking direction, and the support layer 110 may be arranged between the first and second surface pressure layers 121 and 122.

In an embodiment, the support layer 110 may include at least one selected from the group consisting of graphite, mica, aluminum hydroxide, magnesium hydroxide, wollastonite, and aerogel.

In one embodiment, the thickness of the support layer 110 may be between 0.01 mm and 2.5 mm. Specifically, the thickness of the support layer 110 may be 0.03 mm to 2.0 mm, and more specifically, 0.10 mm to 1.5 mm.

In an embodiment, the reinforcement layer (110, 140) further includes the support layer 110, and the support layer 110 may be stacked on at least one of the first barrier layer 131 and the second barrier layer 132 in the stacking direction.

In one embodiment, the reinforcement layer (110, 140) further includes the support layer 110, and the support layer 110 may be arranged between the surface pressure layer 120 and the expansion layer 140.

In an embodiment, the reinforcement layer (110, 140) further includes the support layer 110, and the support layer 110 may be arranged in the stacking direction in at least one of between the expansion layer 140 and the first barrier layer 131 and between the expansion layer 140 and the second barrier layer 132.

In addition, the description of the pad 100 above with reference to FIGS. 1 to 18 may be applied hereto but the present disclosure is not limited thereto.

The pad 100, the battery module 300 and the battery pack 400 according to an embodiment of the present disclosure may be preferably used as a power source of a small or medium-sized device. Examples of the small device include a mobile phone, a notebook computer, a camera, and the like, and examples of the medium-sized device include an electric vehicle, a hybrid electric vehicle, a plug-in hybrid electric vehicle, an electric power storage system, and the like but the present disclosure is not limited thereto.

Hereinafter, embodiments of the present disclosure will be further described with reference to specific experimental examples. Inventive examples and comparative examples included in the experimental examples are merely illustrative of the present disclosure and do not limit the scope of the appended claims, and it is obvious to those skilled in the art that various changes and modifications to the examples are possible within the scope and technical idea of the present disclosure, and it is natural that such changes and modifications fall within the scope of the attached claims.

### EXAMPLES

### Inventive Example 1

A pad in which a first barrier layer, a first expansion layer, a surface pressure layer, a second expansion layer, and a second barrier layer were stacked in a sequential manner was prepared. The first barrier layer and the second barrier layer were each prepared using (woven) ceramic fibers with a thickness of 0.3 mm, and expanded graphite was stacked on each of the first and second barrier layers to form a layer with a thickness of 0.1 mm. The first barrier layer and the second barrier layer on which the expanded graphite layers were stacked were positioned so that the expanded graphite layers faced each other, and silicon foam was foamed at a thickness of 2.2 mm and then bonded to prepare the above pad.

### Inventive Example 2

A pad in which a first barrier layer, a first expansion layer, a first surface pressure layer, a support layer, a second surface pressure layer, a second expansion layer, and a second barrier layer were stacked in a sequential manner was prepared. The first barrier layer and the second barrier layer were each prepared using (woven) ceramic fibers with a thickness of 0.3 mm, and a mixture of expanded graphite and a phosphorus-based flame retardant was stacked on each of the first barrier layer and the second barrier layer to form a layer with a thickness of 0.1 mm (an expansion layer). Silicon foam was foamed at a thickness of 0.85 mm on each of the first barrier layer and the second barrier layer on which the expansion layers were formed.

A 0.1 mm thick PET film was prepared, and a support layer was prepared by coating a mixture of graphite and mica powder to a thickness of 0.4 mm on one side of the prepared film.

The first barrier layer and the second barrier layer in each of which the expansion layer and the silicon foam layer were stacked in a sequential manner were positioned so that the silicon foam layers faced each other, and the support layer was inserted therebetween and bonded to prepare the pad.

### Inventive Example 3

The pad was prepared in the same manner as in Inventive Example 2 except that expanded graphite was stacked on each of the first barrier layer and the second barrier layer so as to form a layer having a thickness of 0.1 mm, and a mica sheet having a thickness of 0.5 mm was used as the support layer.

### Inventive Example 4

A pad in which a first support layer, a first barrier layer, a first expansion layer, a surface pressure layer, a second expansion layer, a second barrier layer, and a second support layer were stacked in a sequential manner was prepared. The first support layer and the second support layer were each prepared with a 0.5 mm thick mica sheet, and 0.3 mm thick ceramic fibers (NCF) were attached to each of the first support layer and the second support layer. A mixture of potassium silicate and a phosphorus-based flame retardant was formed on each of the attached ceramic fibers to form a 0.1 mm thick layer (an expansion layer). The first support layer and the second support layer in each of which the ceramic fibers and the expansion layer were stacked in a sequential manner were positioned so that the expansion layers faced each other, and silicon foam was foamed at a thickness of 1.2 mm and then bonded to prepare the pad.

### Inventive Example 5

A pad in which a first barrier layer, a first expansion layer, a first support layer, a surface pressure layer, a second support layer, a second expansion layer, and a second barrier layer were stacked in a sequential manner was prepared. The first barrier layer and the second barrier layer were each prepared using 0.3 mm thick (woven) basalt fibers, and a mixture of expanded graphite and a phosphorus-based flame retardant was stacked on each of the first barrier layer and the second barrier layer to form a 0.1 mm thick layer (an expansion layer). An aerogel sheet with a thickness of 0.5 mm was attached to each of the first barrier layer and the second barrier layer on which the expansion layers were formed. The first barrier layer and the second barrier layer in each of which the expansion layer and the aerogel sheet were stacked in a sequential manner were positioned so that the respective aerogel sheets faced each other, and silicon foam was foamed at a thickness of 1.2 mm and then adhered to prepare the pad.

### Inventive Example 6

The pad was prepared in the same manner as in Inventive Example 1, except that the thickness of each ceramic fiber was 0.2 mm, the thickness of each expanded graphite layer was 0.015 mm, and styrene butadiene foam was foamed at a thickness of 0.32 mm instead of the silicon foam.

### Inventive Example 7

The pad was prepared in the same manner as in Inventive Example 2 above, except that (woven) glass fibers each having a thickness of 0.4 mm were used instead of the ceramic fibers, sodium silicate was stacked on each of the first barrier layer and the second barrier layer so as to form a layer having a thickness of 0.2 mm (an expansion layer), EPDM foam was foamed at a thickness of 0.9 mm instead of the silicon foam, and a mica sheet having a thickness of 1.5 mm was used as the support layer.

### Inventive Example 8

The pad was prepared in the same manner as in Inventive Example 2 above, except that (woven) aramid fibers of the same thickness were used instead of the ceramic fibers, and a mixture of potassium silicate and a phosphorus-based flame retardant was stacked on each of the first barrier layer and the second barrier layer so as to form a layer having a thickness of 0.1 mm (an expansion layer), silicon foam was foamed at a thickness of 1.0 mm each, and a mica tape of having a thickness of 0.2 mm was used as the support layer.

### Inventive Example 9

A pad in which a first barrier layer, a first surface pressure layer, an expansion layer, a second surface pressure layer, and a second barrier layer were stacked in a sequential manner was prepared. The first barrier layer and the second barrier layer were each prepared using (woven) glass fibers with a thickness of 0.07 mm, and acrylic foam was foamed with a thickness of 0.93 mm on the first barrier layer and on the second barrier layer. Sodium silicate was stacked on the first barrier layer on which the acrylic foam layer was stacked so as to form a layer having a thickness of 1 mm, and the sodium silicate layer and the acrylic foam layer of the second barrier layer were positioned so as to face each other and bonded to each other to prepare the pad.

### Inventive Example 10

The pad was prepared in the same manner as in Inventive Example 2, except that ceramic fibers in the form of short fibers with the same thickness were used instead of the woven ceramic fibers, sodium silicate was stacked on each of the first barrier layer and the second barrier layer to form a layer with a thickness of 0.3 mm (an expansion layer) instead of the above mixture, silicon foam was foamed with a thickness of 0.65 mm each, and a mica sheet with a thickness of 0.5 mm was used as the support layer.

### Inventive Example 11

The pad was prepared in the same manner as in Inventive Example 2, except that glass fibers in the form of short fibers with the same thickness were used instead of the woven ceramic fibers, polyurethane foam was foamed at a thickness of 0.85 mm instead of the silicon foam on each of the first barrier layer and the second barrier layer where the expansion layers were formed, and a mica sheet having a thickness of 0.5 mm was used as the support layer.

### Inventive Example 12

The pad was prepared in the same manner as in Inventive Example 9, except that the thickness of each of the glass fibers was 0.3 mm, silicon foam was foamed at a thickness of 1.2 mm on the first barrier layer and the second barrier layer instead of the acrylic foam, and expanded graphite was stacked to form a layer with a thickness of 0.015 mm on the first barrier layer on which the silicon foam layer was stacked.

### Inventive Example 13

The pad was prepared in the same manner as in Inventive Example 1, except that (woven) glass fibers each having a thickness of 1 mm were used instead of the ceramic fibers, the thickness of the expanded graphite layer was 0.02 mm each, and silicon foam was foamed at a thickness of 0.96 mm.

### Inventive Example 14

A pad in which a first barrier layer, a first expansion layer, a first surface pressure layer, a support layer, a second surface pressure layer, a second expansion layer, and a second barrier layer were stacked in a sequential manner was prepared. The first barrier layer and the second barrier layer were each prepared with 0.3 mm thick (woven) basalt fibers, expanded graphite was stacked on the first barrier layer to form a 0.02 mm thick layer, and sodium silicate was stacked to on the second barrier layer form a 0.3 mm thick layer. Silicon foam was foamed at a thickness of 0.88 mm on the first barrier layer on which the expanded graphite layer was formed, and polyurethane foam was foamed at a thickness of 0.5 mm on the second barrier layer on which the sodium silicate layer was formed.

The first barrier layer in which the expanded graphite layer and the silicon foam layer were stacked in a sequential manner and the second barrier layer in which the sodium silicate layer and the polyurethane foam layer were stacked in a sequential manner were placed so that the silicon foam layer of the first barrier layer and the polyurethane foam layer of the second barrier layer faced each other, and a 0.7 mm thick mica sheet was then inserted therebetween and adhered to prepare the pad.

### Inventive Example 15

A pad in which a first barrier layer, a first expansion layer, a first support layer, a surface pressure layer, a second support layer, a second expansion layer, and a second barrier layer were stacked in a sequential manner was prepared. The first barrier layer was prepared with 0.3 mm thick glass fibers (woven) and the second barrier layer was prepared with 0.1 mm thick (woven) ceramic fibers, and expanded graphite was stacked on each of the first and second barrier layers to form a 0.05 mm thick layer (an expansion layer).

Magnesium hydroxide powder was mixed with an epoxy binder to prepare the first support layer with a thickness of 0.2 mm. A 0.5 mm thick mica sheet was prepared as the second support layer.

The first support layer was attached to the first barrier layer on which the expanded graphite layer was formed, and the second support layer was attached to the second barrier layer on which the expanded graphite layer was formed. The first barrier layer and the second barrier layer were positioned so that the first support layer and the second support layer faced each other, and silicon foam was foamed at a thickness of 1.8 mm and then adhered to prepare the pad.

### Comparative Example 1

The pad was prepared in the same manner as in Inventive Example 1, except that (woven) glass fibers each having a thickness of 0.07 mm were used instead of the ceramic fibers, the thickness of the expanded graphite layer was 0.02 mm each, and silicon foam was foamed at a thickness of 0.32 mm.

### Comparative Example 2

The pad was prepared in the same manner as in Comparative Example 1, except that the thickness of each of the glass fibers was 0.3 mm, the thickness of each of the expanded graphite layers was 0.002 mm, and the silicon foam was foamed to 2.396 mm.

### Comparative Example 3

A pad in which a first expansion layer, a surface pressure layer, and a second expansion layer were stacked in a sequential manner was prepared. The pad was prepared by foaming silicon foam to a thickness of 2.5 mm, stacking sodium silicate on one surface thereof to form a layer with a thickness of 0.3 mm, and stacking expanded graphite on the other surface to form a layer with a thickness of 0.2 mm.

### Comparative Example 4

Silicon foam prepared by foaming at a thickness of 3 mm was prepared as the pad.

### Comparative Example 5

The pad was prepared in the same manner as in Inventive Example 3, except that the thickness of each ceramic fiber was 0.9 mm and the silicon foam was foamed at a thickness of 0.25 mm.

The thicknesses of the pads and the layers of Inventive Examples 1 to 15 are shown in Table 1 below, and the thicknesses of the pads and the layers of Comparative Examples 1 to 5 are shown in Table 2 below.

(unit: mm (a ratio of the thickness of the surface pressure layer to the total thickness of the pad is %), and if the corresponding layer does not exist, it is marked as ‘-’)

TABLE 1

| | In- | In- | In- | In- | In- | In- | In- | In- | In- | In- | In- | In- | In- | In- | In- |
|---|---|---|---|---|---|---|---|---|---|---|---|---|---|---|---|
| | ven- | ven- | ven- | ven- | ven- | ven- | ven- | ven- | ven- | ven- | ven- | ven- | ven- | ven- | ven- |
| | tive | tive | tive | tive | tive | tive | tive | tive | tive | tive | tive | tive | tive | tive | tive |
| | Ex- | Ex- | Ex- | Ex- | Ex- | Ex- | Ex- | Ex- | Ex- | Ex- | Ex- | Ex- | Ex- | Ex- | Ex- |
| | am- | am- | am- | am- | am- | am- | am- | am- | am- | am- | am- | am- | am- | am- | am- |
| | ple 1 | ple 2 | ple 3 | ple 4 | ple 5 | ple 6 | ple 7 | ple 8 | ple 9 | ple 10 | ple 11 | ple 12 | ple 13 | ple 14 | ple 15 |
| Entire pad | 3 | 3 | 3 | 3 | 3 | 0.75 | 4.5 | 3 | 3 | 3 | 3 | 3.015 | 3 | 3 | 3 |
| First | 0.3 | 0.3 | 0.3 | 0.3 | 0.3 | 0.2 | 0.4 | 0.3 | 0.07 | 0.3 | 0.3 | 0.3 | 1 | 0.3 | 0.3 |
| barrier | | | | | | | | | | | | | | | |
| layer | | | | | | | | | | | | | | | |
| Second | 0.3 | 0.3 | 0.3 | 0.3 | 0.3 | 0.2 | 0.4 | 0.3 | 0.07 | 0.3 | 0.3 | 0.3 | 1 | 0.3 | 0.1 |
| barrier | | | | | | | | | | | | | | | |
| layer | | | | | | | | | | | | | | | |
| Expansion | | | | | | | | | 1 | | | 0.015 | | | |
| Layer | | | | | | | | | | | | | | | |
| (Single | | | | | | | | | | | | | | | |
| Layer) | | | | | | | | | | | | | | | |
| First | 0.1 | 0.1 | 0.1 | 0.1 | 0.1 | 0.015 | 0.2 | 0.1 | | 0.3 | 0.1 | | 0.02 | 0.02 | 0.05 |
| expansion | | | | | | | | | | | | | | | |
| layer | | | | | | | | | | | | | | | |
| Second | 0.1 | 0.1 | 0.1 | 0.1 | 0.1 | 0.015 | 0.2 | 0.1 | | 0.3 | 0.1 | | 0.02 | 0.3 | 0.05 |
| expansion | | | | | | | | | | | | | | | |
| Layer | | | | | | | | | | | | | | | |
| Support | — | 0.5 | 0.5 | | | — | 1.5 | 0.2 | — | 0.5 | 0.5 | — | — | 0.7 | |
| layer (in a | | | | | | | | | | | | | | | |
| single | | | | | | | | | | | | | | | |
| layer) | | | | | | | | | | | | | | | |
| First | | | | 0.5 | 0.5 | | | | | | | | | | 0.2 |
| support | | | | | | | | | | | | | | | |
| layer | | | | | | | | | | | | | | | |
| Second | | | | 0.5 | 0.5 | | | | | | | | | | 0.5 |
| Support | | | | | | | | | | | | | | | |
| Layer | | | | | | | | | | | | | | | |
| Surface | 2.2 | | | 1.2 | 1.2 | 0.32 | | | | | | | 0.96 | | 1.8 |
| pressure | | | | | | | | | | | | | | | |
| layer (in a | | | | | | | | | | | | | | | |
| single | | | | | | | | | | | | | | | |
| layer) | | | | | | | | | | | | | | | |
| First | | 0.85 | 0.85 | | | | 0.9 | 1 | 0.93 | 0.65 | 0.85 | 1.2 | | 0.88 | |
| pressure | | | | | | | | | | | | | | | |
| layer | | | | | | | | | | | | | | | |
| Second | | 0.85 | 0.85 | | | | 0.9 | 1 | 0.93 | 0.65 | 0.85 | 1.2 | | 0.5 | |
| pressure | | | | | | | | | | | | | | | |
| layer | | | | | | | | | | | | | | | |
| Ratio of | 73.33 | 56.67 | 56.67 | 40.00 | 40.00 | 42.67 | 40.00 | 66.67 | 62.00 | 43.33 | 56.67 | 79.60 | 32.00 | 46.00 | 60.00 |
| surface | | | | | | | | | | | | | | | |
| pressure | | | | | | | | | | | | | | | |
| layer | | | | | | | | | | | | | | | |
| thickness | | | | | | | | | | | | | | | |
| to total | | | | | | | | | | | | | | | |
| pad | | | | | | | | | | | | | | | |
| thickness | | | | | | | | | | | | | | | |
| (%) | | | | | | | | | | | | | | | |

TABLE 2

| | Comparative | Comparative | Comparative | Comparative | Comparative |
|---|---|---|---|---|---|
| | Example 1 | Example 2 | Example 3 | Example 4 | Example 5 |
| Entire pad | 0.5 | 3 | 3 | 3 | 3 |
| First barrier layer | 0.07 | 0.3 | — | — | 0.9 |
| Second barrier layer | 0.07 | 0.3 | — | — | 0.9 |
| Expansion layer | | | | — | |
| (in a single layer) | | | | | |
| First expansion layer | 0.02 | 0.002 | 0.3 | | 0.1 |
| Second expansion | 0.02 | 0.002 | 0.2 | | 0.1 |
| layer | | | | | |
| Support layer (in a | — | — | — | — | 0.5 |
| single layer) | | | | | |
| First support layer | | | | | |
| Second support | | | | | |
| layer | | | | | |
| Surface pressure | 0.32 | 2.396 | 2.5 | 3 | |
| layer (in a single | | | | | |
| layer) | | | | | |
| First surface | | | | | 0.25 |
| pressure layer | | | | | |
| Second surface | | | | | 0.25 |
| pressure layer | | | | | |
| Ratio of thickness of | 64.00 | 79.87 | 83.33 | 100.00 | 16.67 |
| surface pressure | | | | | |
| layer to total pad | | | | | |
| thickness (%) | | | | | |

### Evaluation Example 1: Evaluation of Heat and Flame Blocking Performance

### 1. Torch Test—Back Temperature Evaluation

A gas torch test was performed on the pads of Inventive Examples 1 to 15 and the pads of Comparative Examples 1 to 5.

Flames at a temperature of 1100° C. to 1200° C. were applied toward one surface (a front surface) of each pad for 300 seconds using a butane gas torch (0.11 Mpa±0.01) at a distance of 140 mm away from one surface (the front surface) of each pad, the temperature of another surface (a back surface) of each pad was then measured, and results are shown in Tables 3 and 4 below.

### 2. Torch Test—Evaluation of Hole Formation

In the same manner as in the torch test of Evaluation Example 1, flames were applied to one surface (a front surface) of each of the pads of Inventive Examples 1 to 15 and each of the pads of Comparative Examples 1 to 5, and whether any hole was formed in one surface (a back surface) of each pad was evaluated. Whether the hole was formed or not was confirmed with the naked eye, and it was marked as O if no hole was formed, and as X when the hole was formed. The evaluation results are shown in Tables 3 and 4 below.

### 3. Fire Delay Testing

A fire delay test was conducted to evaluate the degree of delay in fire propagation using test jigs which may simulate environments in battery modules and packs.

Specifically, a module jig which may simulate a battery module environment and a pack jig which may simulate a battery pack environment were prepared. The module jig and the pack jig include materials and are designed to simulate the actual module and pack internal environments, and an insulation plate (mica) was attached to upper and lower surfaces of the module jig and an inner surface of the pack jig to block the heat flow of the jigs and surroundings. One pad of the present disclosure was arranged per three pouch-type secondary battery cells in the module jig, and the pad was also arranged on each of the outer edge surfaces of the outermost cells at both ends. After a 100×90 mm² heating pad in the form of a winding wrapped in mica was inserted between one of the outermost cells at both ends and the pad on the outer edge surface, the pad was inserted again between the heating pad and the cell to finally form a test stack. A cell voltage meter was connected to each cell, the module jig was put into the pack jig and charging to 100% SOC was performed, and a stabilization process was performed. The initial voltage was 24 V.

The heating pad was heated to a maximum temperature of 250° C. for two minutes. A time from a time point when the temperature of the cell heated by the heating pad was measured as 300° C. to a time point when the measured voltage became 0 V was regarded as an explosion time of the last cell (which is the farthest one from the heating pad), and the time between the above time points was measured as a “fire delay time”. Fire delay times when the pads of Inventive Examples 1 to 15 and the pads of Comparative Examples 1 to 5 were used are shown in Tables 3 and 4 below.

### Evaluation Example 2: Surface Pressure Performance Evaluation

### 1. CFD (Compression Force Deflection) Evaluation

CFD evaluation of the pads of Inventive Examples 1 to 15 and the pads of Comparative Examples 1 to 5 was performed.

Each of the pads of Inventive Examples 1 to 15 and the pads of Comparative Examples 1 to 5 was prepared in a size of 50×50 mm². CFD evaluation was performed on each pad using a universal material tester (ElectroPuls E3000, Instron). Preflex was performed twice at a speed of 250 mm/min up to a range of 75% of the sample thickness, followed by main compression at a speed of 0.5 mm/min to 80% of the sample thickness after resting for 6±1 mins. The CFD was measured by calculating a strain-stress value by recognizing the point where a force of 500 gf was applied to the sample as a zero (0) point, and measurement results are shown in Tables 3 and 4 below.

### 2. Module Swelling Cycle Test Structural Analysis Evaluation

Whether or not a module housing is damaged due to a swelling phenomenon which occurs as battery charge/discharge cycles progress was tested using ABAQUS (Dassault systems) corresponding to a commercial structural analysis program.

24 pouch cells with an area of 550×110 mm² and a cell by stacking five of one out of the pads of Inventive Examples 1 to 15 and the pads of Comparative Examples 1 to 5 were each applied to the housing with a 3 mm thick side wall made of AL5052 for analysis. After a cell swelling level is set to 2.5 mm, the occurrence of cracks in the housing was confirmed based on 1,000 charge/discharge cycles. When no crack occurred, it was marked as O, and when the crack occurred, it was marked as X, and results are shown in Tables 3 and 4 below.

The measurement/evaluation results of Evaluation Examples 1 and 2 performed on the pads of Inventive Examples 1 to 15 and the pads Comparative Examples 1 to 5 are shown in Tables 3 and 4 below.

TABLE 3

| | In- | In- | In- | In- | In- | In- | In- | In- | In- | In- | In- | In- | In- | In- | In- |
|---|---|---|---|---|---|---|---|---|---|---|---|---|---|---|---|
| | ven- | ven- | ven- | ven- | ven- | ven- | ven- | ven- | ven- | ven- | ven- | ven- | ven- | ven- | ven- |
| | tive | tive | tive | tive | tive | tive | tive | tive | tive | tive | tive | tive | tive | tive | tive |
| | Ex- | Ex- | Ex- | Ex- | Ex- | Ex- | Ex- | Ex- | Ex- | Ex- | Ex- | Ex- | Ex- | Ex- | Ex- |
| | am- | am- | am- | am- | am- | am- | am- | am- | am- | am- | am- | am- | am- | am- | am- |
| | ple 1 | ple 2 | ple 3 | ple 4 | ple 5 | ple 6 | ple 7 | ple 8 | ple 9 | ple 10 | ple 11 | ple 12 | ple 13 | ple 14 | ple 15 |
| Back | 246 | 206 | 195 | 185 | 189 | 310 | 170 | 219 | 241 | 190 | 287 | 245 | 181 | 188 | 191 |
| Temperature | | | | | | | | | | | | | | | |
| (° C.) | | | | | | | | | | | | | | | |
| Hole | O | O | O | O | O | O | O | O | O | O | O | O | O | O | O |
| Occurrence | | | | | | | | | | | | | | | |
| Evaluation | | | | | | | | | | | | | | | |
| Fire | 338 | 335 | 445 | 477 | 455 | 188 | 517 | 398 | 340 | 470 | 408 | 308 | 439 | 469 | 467 |
| Delay | | | | | | | | | | | | | | | |
| Time (s) | | | | | | | | | | | | | | | |
| CFD(20%, | 52 | 55 | 51 | 110 | 129 | 213 | 324 | 40 | 12 | 111 | 57 | 30 | 171 | 59 | 40 |
| kPa) | | | | | | | | | | | | | | | |
| Evaluation of | O | O | O | O | O | O | O | O | O | O | O | O | O | O | O |
| Module | | | | | | | | | | | | | | | |
| Damage | | | | | | | | | | | | | | | |

TABLE 4

| | Comparative | Comparative | Comparative | Comparative | Comparative |
|---|---|---|---|---|---|
| | Example 1 | Example 2 | Example 3 | Example 4 | Example 5 |
| Back Temperature | 412 | 380 | 518 | 660 | 178 |
| (° C.) | | | | | |
| Hole Occurrence | X | O | X | X | O |
| Evaluation | | | | | |
| Fire Delay Time (s) | 95 | 108 | 53 | 43 | 497 |
| CFD(20%, kPa) | 38 | 31 | 30 | 23 | 10000↑ |
| Evaluation of Module | O | O | O | O | X |
| Damage | | | | | |

Referring to Inventive Examples 1 to 15, it was confirmed that a pad according to an embodiment of the present disclosure has excellent heat and flame blocking performance even with a relatively small thickness, and at the same time, it is also confirmed that the surface pressure performance is also excellent. A battery module according to an embodiment of the present disclosure includes the above pad, and thus it may be confirmed that the battery module has excellent stability and safety.

Comparative Example 1 has a structure similar to that of the pad according to one embodiment of the present disclosure, but it was confirmed that the heat and flame blocking performance was poor because the total pad thickness was too small.

Comparative Example 2 has a structure similar to that of the pad according to one embodiment of the present disclosure, but it was confirmed that the heat and flame blocking performance was poor because the reinforcement layer, especially the expansion layer, was too thin.

In Comparative Examples 3 and 4, unlike the pad according to one embodiment of the present disclosure, all or part of the configurations for blocking heat and flame were omitted, and thus, it was confirmed that the heat and flame blocking performance was very poor.

Comparative Example 5 has a structure similar to that of the pad according to one embodiment of the present disclosure, but it was confirmed that the surface pressure performance was very poor because the thickness of the surface pressure layer, especially the ratio of the thickness of the surface pressure layer to the total thickness is too low.

According to an aspect of the present disclosure, it is possible to provide a pad capable of achieving high heat resistance performance with a small thickness, and at the same time, effectively mitigating the influence of a swelling phenomenon.

According to another aspect of the present disclosure, it is possible to provide a battery module and a battery pack with improved safety and minimized volume increase.

Meanwhile, the present disclosure can be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A pad comprising:
a surface pressure layer having a shape of a sheet;
a first barrier layer and a second barrier layer respectively stacked on both surfaces of the surface pressure layer in a predetermined stacking direction; and
a reinforcement layer arranged in the predetermined stacking direction.

2. The pad according to claim 1, wherein a thickness of the pad is between 0.55 mm and 5.5 mm.

3. The pad according to claim 1, wherein the first barrier layer and the second barrier layer each independently comprise at least one selected from fibers and an inorganic material.

4. The pad according to claim 1, wherein thicknesses of the first barrier layer and the second barrier layer are each independently from 0.05 mm to 1.0 mm.

5. The pad according to claim 1, wherein the surface pressure layer comprises at least one selected from the group consisting of silicone, polyurethane (PU), acrylic, Ethylene-Propylene Diene Monomer (EPDM), Ethylene Vinyl Acetate (EVA), isoprene rubber, butadiene rubber, chloroprene rubber, and butyl rubber.

6. The pad according to claim 1, wherein a thickness of the surface pressure layer is between 0.2 mm and 4.0 mm.

7. The pad according to claim 1, wherein a thickness of the surface pressure layer is between 20% and 82% of a total thickness of the pad.

8. The pad according to claim 1, wherein the reinforcement layer comprises an expansion layer, and
wherein the expansion layer is arranged in the predetermined stacking direction in at least one of between the surface pressure layer and the first barrier layer and between the surface pressure layer and the second barrier layer.

9. The pad according to claim 8, wherein the expansion layer comprises at least one selected from the group consisting of expanded graphite, silicate, and phosphorus-based flame retardants.

10. The pad according to claim 8, wherein a thickness of the expansion layer is between 0.015 mm and 1.0 mm.

11. The pad according to claim 1, wherein the reinforcement layer comprises an expansion layer,
wherein the surface pressure layer includes a first surface pressure layer and a second surface pressure layer stacked in the predetermined stacking direction, and
wherein the expansion layer is arranged between the first surface pressure layer and the second surface pressure layer.

12. The pad according to claim 8, wherein the reinforcement layer further comprises a support layer,
wherein the surface pressure layer includes a first surface pressure layer and a second surface pressure layer stacked in the predetermined stacking direction, and
wherein the support layer is arranged between the first surface pressure layer and the second surface pressure layer.

13. The pad according to claim 12, wherein the support layer comprises at least one selected from the group consisting of graphite, mica, aluminum hydroxide, magnesium hydroxide, wollastonite, and aerogel.

14. The pad according to claim 12, wherein a thickness of the support layer is between 0.01 mm and 2.5 mm.

15. The pad according to claim 8, wherein the reinforcement layer further comprises a support layer, and
wherein the support layer is stacked on at least one of the first barrier layer and the second barrier layer in the predetermined stacking direction.

16. The pad according to claim 8, wherein the reinforcement layer further comprises a support layer, and
wherein the support layer is arranged between the surface pressure layer and the expansion layer.

17. The pad according to claim 8, wherein the reinforcement layer further comprises a support layer, and
wherein the support layer is arranged in the predetermined stacking direction in at least one of between the expansion layer and the first barrier layer and between the expansion layer and the second barrier layer.

18. A battery module, comprising:
a plurality of battery cells stacked in a predetermined stacking direction;
a module case accommodating the plurality of battery cells; and
a pad arranged between at least one pair of battery cells adjacent to each other among the plurality of battery cells,
wherein the pad comprises:
a surface pressure layer having a shape of a sheet;
a first barrier layer and a second barrier layer respectively stacked on both surfaces of the surface pressure layer in the predetermined stacking direction; and
a reinforcement layer arranged in the predetermined stacking direction of the pad.

19. The battery module according to claim 18, wherein the plurality of battery cells are stacked to include at least one battery cell having one surface where the pad is arranged, and another surface, opposing the one surface, where the pad is not arranged.

20. A battery pack, comprising:
a battery cell stack; and
a housing accommodating the battery cell stack comprising a plurality of battery cell stacks,
wherein the battery cell stack comprises:
a plurality of battery cells stacked in a predetermined stacking direction; and
a pad arranged between at least one pair of battery cells adjacent to each other among the plurality of battery cells, and
wherein the pad comprises:
a surface pressure layer having a shape of a sheet;
a first barrier layer and a second barrier layer respectively stacked on both surfaces of the surface pressure layer in the predetermined stacking direction; and
a reinforcement layer arranged in the predetermined stacking direction.
